(19) United States
(12) Patent Application Publication
(10) Pub. No.: US 2024/0168480 A1
(43) Pub. Date: May 23, 2024

(54) AUTONOMOUS MAPPING BY A MOBILE ROBOT

(71) Applicant: Omron Corporation, Kyoto (JP)

(72) Inventors: Karthik Mahesh Varadarajan, San Ramon, CA (US); John Drinkard, San Ramon, CA (US)

(21) Appl. No.: 17/993,592

(22) Filed: Nov. 23, 2022

(51) Int. Cl. G05D 1/02; G05D 1/00; G06N 3/04; G06T 7/579

(52) U.S. Cl. CPC G05D 1/0214; G05D 1/0077; G05D 1/0217; G05D 1/0238; G05D 1/0274; G06N 3/04; G06T 7/579; G06T 2207/20081; G06T 2207/20084; G06T 2207/30261

(57) ABSTRACT

An autonomous mapping system defines the exploration behavior of a mobile robot in a physical environment, according to a multi-objective optimization. With multi-objective optimization, the exploration behavior of the robot depends on joint consideration of two or more exploration objectives, such as speed, coverage, and consistency. In at least one embodiment, the autonomous mapping system is user customizable via a user interface that, among other things, allows a user to prioritize and/or select the exploration objectives considered in the multi-objective optimization. The autonomous mapping system in one or more embodiments incorporates advantageous formulations such as loop closure prediction for consistent mapping, kinodynamic prioritization for smooth trajectory generation, local refinement to improve map coverage, a time-based blacklisting table to manage exploration goals, a 2D attraction layer and recovery behaviors for efficient path planning, and a recommendation system enabling an operator/user to refine subsequent exploration runs, especially for remapping.

### TECHNICAL FIELD

This disclosure generally relates to mobile robots, and particularly relates to methods and apparatuses for autonomous mapping of a physical environment by a mobile robot.

### BACKGROUND

Mapping for industrial mobile robots typically requires a skilled human operator to guide the robot around the physical environment of interest, collecting data from sensors on the robot. A map is then constructed offline on a computer, using a SLAM technique. The map is further adjusted offline by a skilled operator to omit any “keep-out” areas, or to correct areas that have not been mapped correctly by the offline process. Once the map is created, it is not updated until the environment changes so much that remapping is needed.

A robot navigating in the environment represented by the map creates a path plan using configured start and end goals defined within the map and it executes the path plan using a localization algorithm that allows the robot to determine its location and direction as it moves within the environment. SLAM is not executed continuously because it is not always possible to differentiate between which features are static and which are not, and errors in the executed plan may happen as a result.

In the commercial home vacuum market, there are robotic vacuum cleaners equipped with autonomous mapping capability. See U.S. Pat. No. 9,188,983 B2 for example. Such systems use a real time SLAM algorithm to look for “frontiers,” where “frontier” refers to the boundary between known (mapped) and unknown (unmapped) regions, and then try to map them. Unmapped regions with the largest frontier boundaries are prioritized. The mapping process completes when there are no more frontiers larger than some specified limit. The user can preemptively configure “keep out” zones using panels or other techniques, such as seen in U.S. Pat. No. 9,854,737 B2. The result is a map that the robots can use to make sure the space enclosed by the map can be covered by the robot completely. Accurate following of a specified path is less important in this context. While the basic frontiers approach works well for small spaces such as homes, it has practical limitations in the context of large spaces, such as factories or other industrial or commercial environments.

### SUMMARY

A mobile robot operates as an autonomous mapping system, with the robot implementing an autonomous mapper that defines the exploration behavior of the robot in a physical environment according to a multi-objective optimization. The multi-objective optimization depends on joint consideration of two or more exploration objectives. In at least one embodiment, the autonomous mapping system is user customizable via a user interface that, among other things, allows a user to prioritize and/or select the exploration objectives considered in the multi-objective optimization.

One or more embodiments comprise a method of autonomous mapping by a mobile robot, which includes the robot identifying a next frontier for exploration from among two or more candidate frontiers in a map generated by the mobile robot using an online Simultaneous Localization and Mapping (SLAM) algorithm. The identification is based on the robot solving, for each candidate frontier, a multi-objective optimization that jointly evaluates a set of two or more exploration objectives to determine an attractiveness of the corresponding candidate frontier as a next exploration goal. Each one of the two or more exploration objectives is a respective type of exploration objective. The method further includes the robot planning a global path to a global waypoint on the next frontier and navigating to the global waypoint according to the global path, subject to collision avoidance and path parameterization determined by local path planning driven by environmental sensors onboard the robot.

One or more embodiments comprise a computer-implemented method of customizing the exploration behavior of a mobile robot, based on displaying a user interface corresponding to a physical environment to be mapped by a mobile robot. Here, an autonomous mapper drives the mobile robot to explore the physical environment, based on selecting frontiers for exploration according to a multi-objective optimization that considers two or more exploration objectives of respective objective types. For example, a first exploration objective biases exploration for mapping accuracy and a second exploration objective biases exploration for mapping speed. More broadly, different types of objectives-expressed as objective functions-represent different exploration biases, such as exploration that is more aggressive or less aggressive with corresponding tradeoffs in higher or lower risks of the robot becoming lost, or exploration that is more time consuming or less time consuming with corresponding tradeoffs in the completeness or accuracy of the resulting environment map.

Multi-objective optimization provides for advantageous consideration and balancing of competing exploration objectives. In one or more embodiments, the multi-objective optimization allows for user input to select which exploration objectives are considered in the multi-objective optimization or set priorities for resolution of optimization tradeoffs among the two or more exploration objectives subject to simultaneous optimization.

In one or more embodiments, the autonomous mapping system performs any one or more of the following, responsive to receiving corresponding user input via the user interface: limiting search spaces and mapping regions; prioritizing mapping regions; choosing termination criteria and bounding strategies; choosing exploration strategies, constraints, and parameters; choosing static trajectories; customizing relative weights or priorities for multiple exploration objectives evaluated by the mobile robot in a multi-objective optimization that controls an exploration behavior of the mobile robot; and specifying safety constraints.

Another embodiment comprises a computer-implemented method of providing live feedback and exploration process control of a mobile robot that implements an autonomous mapper as described above. The method includes visualizing the robot-generated map, obstacles, robot position, planned global and local paths, cost maps and frontiers, frontier priority, and blacklisting status, and providing user input controls for changing frontier priority, blacklisting status, aborting, or stopping the exploration process when the robot makes an unsafe maneuver, and rolling back a variable number of trajectories in case of incorrect mapping.

A mobile robot according to one or more embodiments includes a drive system configured to move the mobile robot within a physical environment, one or more sensors configured to sense obstacles in the physical environment, within corresponding sensing ranges, and processing circuitry.

The processing circuitry is configured to identify a next frontier for exploration from among two or more candidate frontiers in a map generated by the mobile robot using an online SLAM algorithm. The identification is based on the processing circuitry solving, for each candidate frontier, a multi-objective optimization that jointly evaluates a set of two or more exploration objectives to determine an attractiveness of the corresponding candidate frontier as a next exploration goal. Here, each one of the two or more exploration objectives is a respective type of exploration objective. The processing circuitry is further configured to plan a global path to a global waypoint on the next frontier and navigate to the global waypoint according to the global path, subject to collision avoidance and path parameterization determined by local path planning driven by environmental sensors onboard the robot.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a block diagram of data and control flow in an autonomous mapper, according to one or more embodiments.

FIG. 2 is a block diagram illustrating relative operational timing among or between the various constituent modules or functions of an autonomous mapper, according to one or more embodiments.

FIG. 3 is a block diagram illustrating a simplified system diagram of constituent modules of an autonomous mapper, according to one or more embodiments.

FIGS. 4A and 4B are block diagrams illustrating additional details for the system diagram depicted in FIG. 3.

FIG. 5 is a block diagram of a Generative Adversarial Network (GAN) that is used for loop closure prediction, according to one or more embodiments.

FIG. 6 is a block diagram illustrating exploration states and user interfaces of an autonomous mapper, according to one or more embodiments.

FIG. 7 is a block diagram illustrating a user interface for customizing behavior of an autonomous mapper, according to one or more embodiments.

FIG. 8 is a block diagram illustrating a feedback interface of an autonomous mapper, according to one or more embodiments.

FIG. 9 is a block diagram of a mobile robot, according to one or more embodiments.

FIGS. 10-14 are block diagrams illustrating example implementation details of a mobile robot, according to one or more embodiments.

FIG. 15 is a block diagram illustrating a mobile robot and an associated computer system, according to one or more embodiments.

FIG. 16 is a diagram illustrating example tuning parameters for configuring autonomous-mapping behaviors, according to one or more embodiments.

FIG. 17 is a logic flow diagram illustrating a method of operation by a mobile robot for autonomous mapping, according to one or more embodiments.

FIG. 18 is a logic flow diagram illustrating example details for the method depicted in FIG. 17.

### DETAILED DESCRIPTION

This document describes methods and apparatuses for autonomous mapping by mobile robots. An “autonomous mapper” according to the disclosed techniques replaces the laborious manual mapping of large industrial environments prior to deployment of robots. In particular, the autonomous mapper provides an automated process that shortens the time needed for environment mapping, while minimizing human involvement. When used without qualification, the term “autonomous mapper” refers to the functionality embodied in the disclosed techniques, with the understanding that such functionality is realized via the onboard processing and control systems of a mobile robot that carries out the mapping operations.

“Exploration framework” and “autonomous mapper” are interchangeable terms in this disclosure, whereas related terms like “exploration suite” refer to sub-systems or constituent functions encompassed within the autonomous mapper.

A mobile robot implements the autonomous mapper to plan and execute a path through an environment, targeting regions where there is no established map, while at the same time using SLAM techniques to localize its position and build a map that is representative of the environment. A notable aspect of the autonomous mapper is that it operates according to a multi-objective optimization. With the multi-objective optimization, the mobile robot chooses exploration goals for exploring a physical environment, based on jointly evaluating a set of two or more exploration objectives with respect to each frontier that is a candidate for selection as a next exploration goal.

Each exploration objective is represented as an objective function, whose value is to be minimized or maximized. One or more of the objective functions may be in tension with one or more other ones of the objective functions, such that multi-objective optimization involves the mobile robot determining an optimum trade off or balancing of the multiple exploration objectives. For example, there may be one or more speed-related objectives that bias the exploration behavior of the mobile robot towards mapping speed. However, mapping speed may be in tension with mapping accuracy and/or mapping completeness, where those objectives are represented by respective objective functions considered in the multi-objective optimization. Additional example objectives include ones related to the smoothness of motion by the mobile robot, or related to robustness, e.g., resistance to loss of localization, battery life, etc.

In at least one embodiment, the mobile robot includes memory or other storage from which it reads user-configured values or data to tune its multi-objective optimization.

Thus, in one or more embodiments, an autonomous mapping system as disclosed herein comprises a mobile robot that instantiates and runs an example of the autonomous mapper, and it allows human intervention when necessary to establish parameters, such as goals, and/or the definition of keep out areas and emergency stops. By retaining such human configured map elements, the system also greatly simplifies re-mapping of environments that experience dynamic changes (not affecting these elements) during operation of the robot. The system also finds potential use in target discovery. The example system may further include supporting logic available via a PC or other interface device, for users to input configuration parameter values for tuning the autonomous mapper.

Achievement of Level 5 autonomy as defined by the Society of Automotive Engineers (SAE) is possible with the autonomous mapper, but less complex and inexpensive implementations of the autonomous mapper provide Level 2 autonomy with distinct advantages. In such contexts, the autonomous mapper supports user monitoring of autonomous mapping, to enable execution of an “abort” during sensor or decision system failure on a potentially hazardous navigation behavior.

The autonomous mapper achieves significant reductions in mapping time as compared to manual mapping by choosing the shortest paths, keeping the farthest distance from structures in the environment depending on the detection capabilities of the sensors used by the mobile robot for mapping, while maximizing map quality, coverage, completeness, and localization accuracy. A human operator working the same region will be unable to determine optimal paths that reduce time while improving localization performance and map quality without feedback from the robot, which is generally unavailable in a manual mapping step. Furthermore, the operational speeds for a robot operating according to the disclosed autonomous mapper are much higher than that of a human operator walking around with a robot for a mapping operation. Such speed reduces the number of man-hours required for mapping. Further, because a line of sight visual or remote monitoring of the mapping robot by an operator is typically sufficient, the autonomous mapper provides significant reductions in operator workloads.

An example embodiment comprises an autonomous mapper in a mobile robot, and it offers advantages in contexts requiring precise navigation in large spaces or requiring improved flexibility for remapping. Herein, the term “mobile robot” has broad meaning unless otherwise qualified in context, and it encompasses a wide range of wheeled and tracked vehicles such as industrial robots or autonomous vehicles, and further encompasses drones and other aerial vehicles, along with autonomous watercraft.

Among its various advantages, one key advantage is the use of a multi-objective optimizer by the autonomous mapper. The multi-objective optimizer maximizes map coverage, while minimizing the time required for mapping. The multi-objective optimizer, which comprises specific processing and computational operations implemented via the execution of corresponding computer program instructions, for example, also maximizes global map accuracy by prioritizing paths for the robot through frontiers that enable loop closures—i.e., registration of a current view with respect to reliably identified landmarks in the environment.

The techniques embodied in the multi-objective optimizer improve over the current state of the art, centered around frontiers-based mapping prioritizing the largest frontier to maximize coverage, but without a multi-objective optimization that exploits the trade-offs between various opportunistic exploration choices. For example, in one or more embodiments, the multi-objective optimization embodied in the disclosed autonomous mapper jointly considers more than one objective function, with each objective function embodying a different exploration goal, such as more comprehensive exploration, or fastest exploration, etc. Joint optimization balances the tradeoffs between, for example, mapping time and global map accuracy. In at least one embodiment, the autonomous mapper incorporates or supports a user interface that exposes certain parameters of the optimization algorithm(s), thus providing users with an advantageous mechanism for “tuning” the optimization behavior of the mobile robot(s) that implement the autonomous mapper. For example, users can tune for mapping speed or mapping accuracy or can tune for more aggressive exploration or less aggressive exploration. Broadly, embodiments of the autonomous mapper provide users with the advantageous ability to balance various tradeoffs made by the robot during mapping.

With the term “exploration suite” referring to constituent functions or sub-systems comprised within the overall autonomous mapper or exploration framework, the exploration suite determines global way points for navigation as a multi-objective optimization problem seeking to maximize map quality, coverage and localization score while also minimizing mapping distance covered and time taken to complete the exploration process. These sets of objectives are opposing and involve making trade-offs, which is managed by the multi-objective optimizer. How the optimizer balances the trade-offs is “tunable” at least in part by the user to their specific needs or requirements.

The exploration suite influences the path planning in a way that forces loop closure to happen during the exploration process by a robot that implements the optimizer. The forcing of loop closures is done by predicting how to reach a landmark as the robot moves through an unmapped frontier (henceforth termed “predictive mapping”). This approach not only ensures accuracy through loop closure, but also prevents the robot from getting lost (i.e., losing localization).

The exploration suite uses kino-dynamic prioritization that places low priority on paths that are likely to require deviation from the robot's current heading direction, thereby minimizing the probability of change in direction of the executed path. This behavior offers advantages, not least in that the resulting paths taken by the robot will be smoother and present a more predictable behavior around humans. Moreover, smoother trajectories improve battery performance and prolong mechanical life of motors and drive systems on the robot.

The trajectory of the robot to an optimized waypoint is further subject to a local refinement process that refines the trajectory by adding waypoints that enable the robot to capture local map structures from a variety of viewpoints, which improves local map coverage.

The exploration suite in one or more embodiments also uses a time-based blacklisting table to reject goals deemed unreachable by the global planner. Unlike traditional blacklisting tables, which always remember these goals, the time-based blacklisting table assigns an expiration time to the table entries.

Other notable aspects of the exploration suite are the use of a global planner that pushes the robot to be in the vicinity of visible structures during mapping. The global planner utilizes a 2D attraction layer, as explained later herein.

The exploration suite also uses a local planner that employs recovery behaviors comprising “cost map” alterations and local recovery behaviors that include, for example, backtracking, spinning and U-turns. These local recovery behaviors allow the robot to extricate itself when it enters a stuck state.

The autonomous mapping system is customizable in one or more embodiments, enabling a user to limit, and prioritize map regions, manage trajectories, exploration strategies and specify safety considerations. Additionally, in at least one embodiment a recommendation function provides exploration analytics, evaluation, and feedback in the form of a recommendation system that can be used by the operator to refine and fine-tune current and future exploration and re-mapping runs.

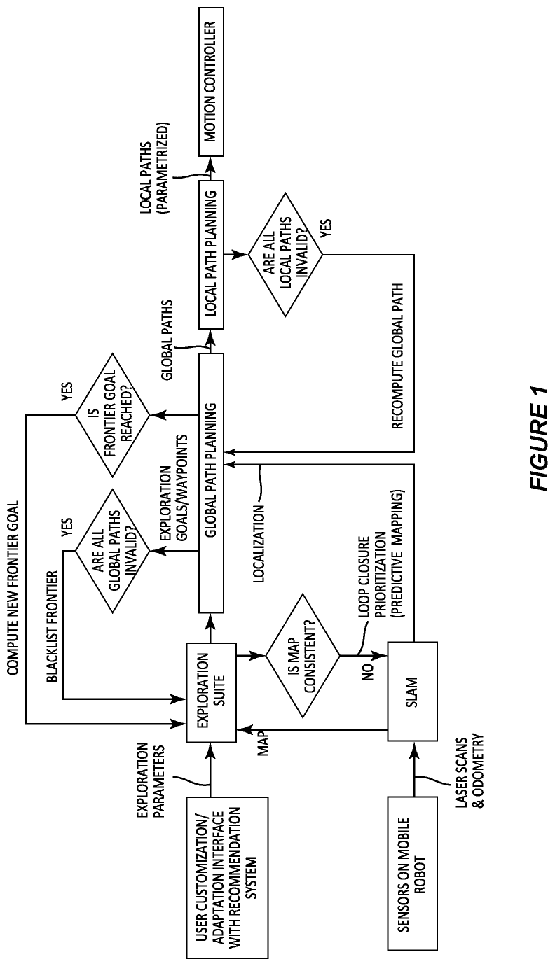

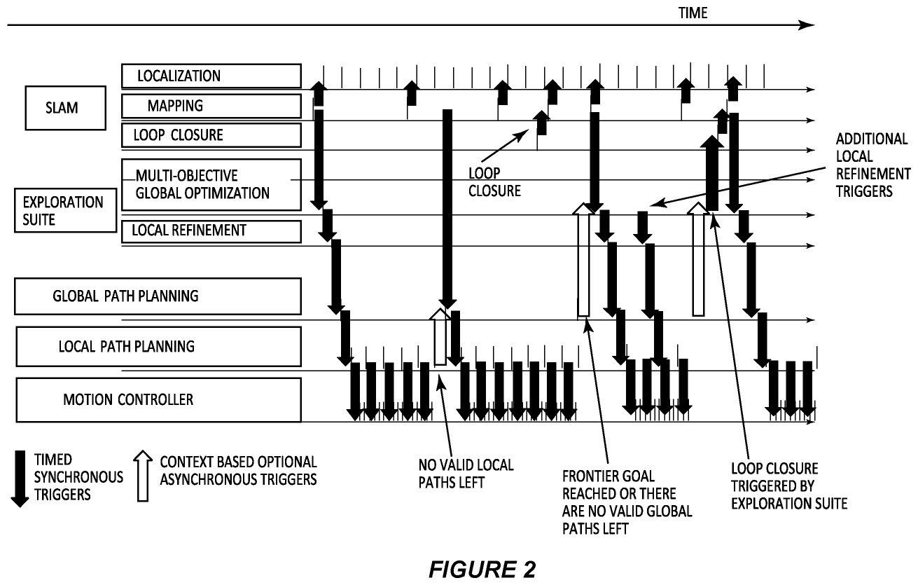

A basic function of the autonomous mapper according to one or more embodiments is illustrated in FIGS. 1 and 2. In an example context, the robot being used for autonomous mapping according to the disclosed techniques is a differential drive industrial mobile robot with one or more two-dimensional (2D) laser scanners and/or sonar range devices, and where the processing system of the robot has access to odometry information, e.g., via wheel encoders and an Inertial Measurement Unit (IMU) or similar. It is also assumed that the robot builds and uses a 2D occupancy map for localization. However, the disclosed techniques apply directly to, or are extendable to other types of robots including Unmanned Arial Vehicles (UAVs), Unmanned Surface Vehicles (USVs), Unmanned Ground Vehicles (UGVs) etc., with or without additional sensors such as three-dimensional (3D) Lidars, vision cameras, etc.

The exploration framework in one or more embodiments comprises (a) modules that interact with the sensors on the mobile robot, (b) an exploration suite that solves the multi-objective optimization problem to come up with best estimates of exploration locations and next best waypoints (i.e., where to explore and how to explore) based on user specified constraints, (c) a SLAM module that generates an online map using sensor data based on locations explored, (d) a global path planner to create paths to exploration locations identified by the exploration suite, (e) a local path planner to compute parametrized local paths while avoiding obstacles, and (f) a motion controller to translate command positions into velocities. In at least one embodiment, the exploration framework further comprises a user interface with options to control one or more aspects of the exploration process. For example, the user interface accepts user input and an exposure function included in the exploration framework adjusts the value(s) of one or more configuration parameters that influence exploration behavior, responsive to user inputs received via the user interface.

FIG. 1 illustrates an example exploration framework at a high level and indicates example data and control flow through the various blocks. Here, the respective blocks may be understood as functions or collections of related functions that are realized, for example, via the execution of computer program instructions by one or more microprocessors or other digital processing circuitry that is specially adapted for operations as an autonomous mapper.

The data from sensors on board the mobile robot, comprising optical data (chiefly laser scans) and odometry, for example, is streamed to the Simultaneous Localization and Mapping (SLAM) module that generates a map of the environment, while simultaneously localizing the robot in the map. During this step, the autonomous mapper executing onboard the robot also runs a loop closure optimization process at regular intervals, based on revisits of previously mapped areas.

The map from SLAM is then input to the exploration suite. Based on a set of exploration parameters, which are user-tunable in one or more embodiments, the exploration suite computes the optimal goal or waypoint at which to conduct exploration, using a multi-objective global optimization process. Identifying and navigating to waypoints can be understood as elements of the exploration process carried out by the mobile robot according to the exploration framework instantiated by the processing circuitry of the robot.

The exploration goals/waypoints are then sent to the global path planner that generates paths to each goal. If no valid paths are available, either because it cannot find a valid path, or all computed paths are later determined to be viable by the local planner (as discussed later), the global planner signals the exploration suite to blacklist the current goal and fetch the next goal for planning. Using the localization information from the SLAM module, the global path planner can also determine if the exploration goal is reached. If so, it signals the exploration suite to send a new goal at which to explore next.

The global path is then sent to the local path planner that parameterizes a local segment of the global path, based on the current position of the robot, and into a form that is suitable for actuation, while simultaneously avoiding obstacles. The required local pose along the local paths is then sent to the motion controller that converts these positions into velocities for actuation of the differential drive motors of the robot.

The local planner recomputes local paths if a collision free path cannot be identified or if the robot is repeatedly stopped from executing the planned path by obstacles in its vicinity. There is a limit on the number of local paths that the planner can compute and retry. If this limit is reached, i.e., all local paths are invalid, the local planner signals the global planner to recompute a global path. It is also possible that all such recomputed global paths are found to be unviable.

FIG. 2 depicts an example timing diagram. The timing diagram is a simplified representation of relative operational timing between various blocks or modules of the exploration framework, including periodic synchronous triggers or signals, as well as context-specific asynchronous triggers for exemplar contexts.

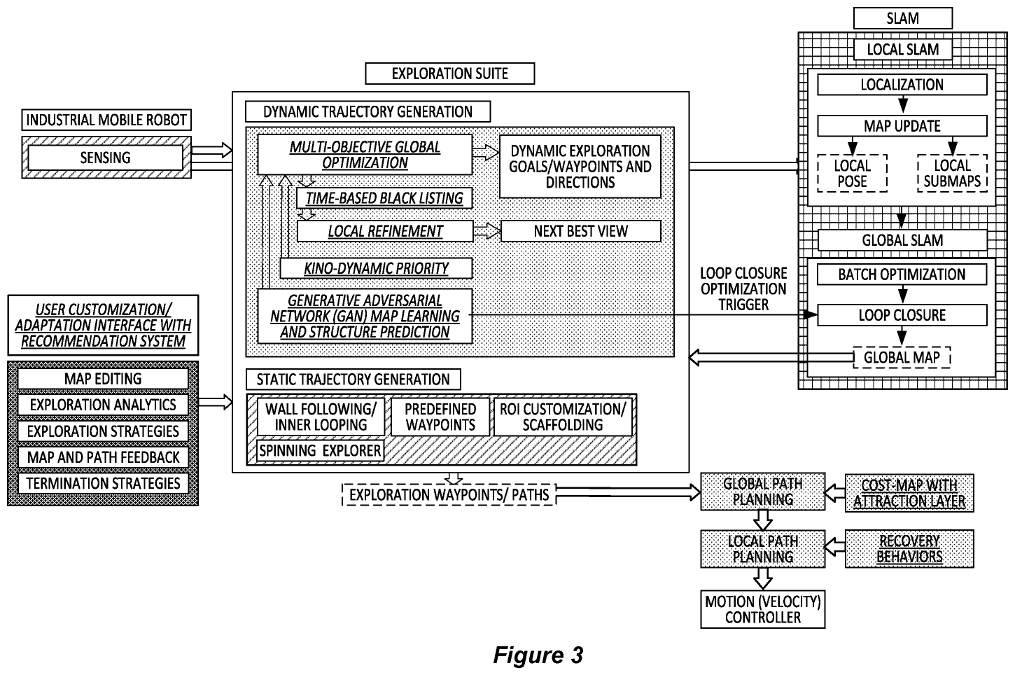

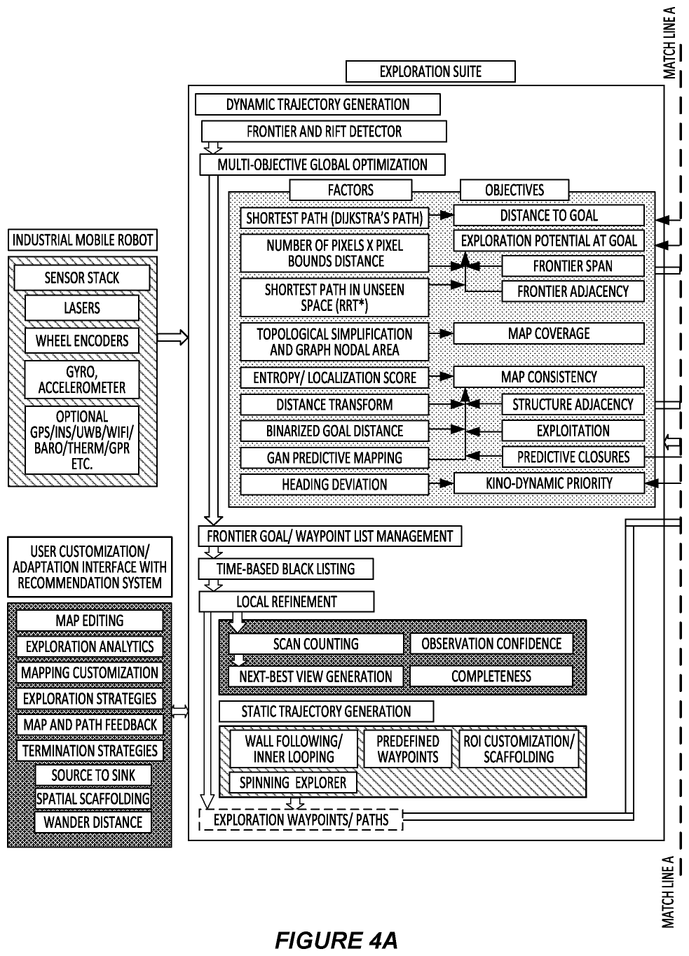

The system level description of the exploration framework according to one or more example embodiments is shown in terms of its notable constituent modules in FIG. 3. The exploration suite is shown in the middle of FIG. 3, with FIGS. 4A and 4B providing a detailed view, according to one or more embodiments. The supporting algorithms and system components that enable the exploration framework are also shown in FIGS. 3 and 4A/B. As defined earlier, these include the industrial mobile robot hardware with sensors, the global path planning and local path planning modules, the motion (velocity) controller, SLAM, and user interfaces.

The following sections describe each module depicted in FIGS. 4A and 4B.

Exploration Suite—Dynamic Trajectory Generation

The exploration suite supports dynamic trajectory generation for operation with minimal user intervention, while also supporting static trajectory generation with user inputs. A dynamic trajectory generation module of the exploration suite solves a multi-objective optimization problem, with the solutions determining the next global waypoints to travel to, along with an associated direction of travel. This waypoint information (position variable) is subject to a local refinement step that determines local position and direction. The local refinement step also works independently to refine the local trajectory between global waypoints. The output of the multi-objective global optimization and local refinement—goal/waypoint and associated direction—is used by the global planner to build trajectories.

Dynamic Trajectory Generation—Global Waypoint Estimation

This section describes the approach to formulating exploration in terms of multi-objective optimization with specific objectives for optimization. The global waypoints chosen by the multi-objective optimization can be optimal or along a non-dominated/Pareto-optimal front. That is, it is possible to obtain unique solutions, or multiple solutions which are equally optimal, with each solution performing well on one objective function considered in the multi-objective optimization, but not performing well with respect to one or more other objective functions considered. The multi-objective optimization according to one or more embodiments of an autonomous mapper is composed of several factors and corresponding variables, over which the optimization is carried out using multiple objective functions. The multi-objective optimization problem may be framed in terms of the equation below:

min(ƒ₁(x),ƒ₂(x),ƒ₃(x), . . . ,ƒₖ(x)) (1)

s.t.x∈X

Where the ƒᵢ(x) are the respective objective functions to be minimized and X is the feasible set of decision vectors. Again, each objective function corresponds to a respective robot behavior or attribute, such as mapping speed, mapping accuracy, power efficiency, trajectory smoothness, etc.

These objectives are linearly re-weighted to obtain a scalarized objective leading to a single objective optimization, which is further simplified. The scalarized form of the optimization in terms of its multiple objective functions is given by

$${min}_{x ∈ X} {\sum }_{i = 1}^{k} {p}_{i} {w}_{i} {f}_{i} ( x ) \qquad ( 2 )$$

Here wᵢ are weights for scalarization. These weights are set equal to 1 at the beginning of the optimization process. This is further re-weighted by a priority factor pᵢ which depends on specific conditions as discussed later. Weights can be customized by the user for specific use cases. The individual objective functions ƒᵢ(x) can further be subjected to additional constraints that can be used to simplify the scalarized optimization function.

The constraints on the objective functions may be represented as

ε_{i,l}≤ƒᵢ(x)≤ε_{i,u} for i∈{1, . . . ,k} (3)

With ε_{i,l} and ε_{i,u} representing the min and max bounds for objective i.

In principle, because the solution space (comprising frontier goals/waypoints as discussed in the next section) is discrete, it is possible to solve such a system (i.e., find the index to the frontier to explore next, as described in the next section) using a brute force approach (i.e., by evaluating the objectives for all points in the solution space), if the list of frontier goals is not large. In large environments, the list might be large enough to make the search for a solution intractable. In such cases, approximate solutions in the form of a mixed-integer linear programming (as some of the objectives may be binary, some integer and others real) can be obtained.

These approximate solutions may or may not produce the optimal solution across all objective functions—i.e., they may not produce the global minima for the scalarized (also called blended) objective function. Using approximate solutions generated by solvers, where more than one index might be identified by the multi-objective optimization, the frontier goal/waypoint index with the closest distance to the current location of the robot is identified and used in the next stage of the processing. The scalarized form with blended objectives is solved using branch and bound, along with gradient descent for local solutions at the bounds. For example details of such solvers, see Deb, K. (2014), “Multi-objective optimization,” (pp. 403-449), Springer, Boston, MA. This offers a simple and quick approach to solving the problem.

This multi-objective optimization can also be solved using alternate solvers, including approximate solvers. More complex approaches such as hierarchical or lexicographical approaches, multi-objective degradation and hybrid approaches supported by popular solvers can also be used. It is also possible to solve such a system with solvers that support evolutionary algorithms, including particle swarm optimization.

### Global Waypoint Estimation—Solution Space

The solution to the above multi-objective optimization problem (i.e., x∈X) is defined in terms of waypoints or goal points placed on frontiers. In other words, the overall purpose of the optimization is to choose one among a list of frontier goals. A description of frontiers is presented below.

Frontiers are used to identify potential goals for exploration. Frontiers are established as pixel neighborhoods of boundaries between seen (unoccupied) and unseen (unscanned) spaces in the current map generated by SLAM (see the section herein on SLAM for Map Generation). Here, the term “seen” corresponds to prior optical sensor observations of either an obstacle at the specified location in the space or a free/unoccupied location through which a scan ray from the sensor has passed before an obstacle behind this location had been detected. These locations form cells in an occupancy map. “Unseen” locations correspond to cells in the occupancy map at which no obstacles have been detected or through which no prior sensor ray traces to obstacles have occurred. The goal of exploration is to navigate to these frontiers, to visit unseen areas and thereby add those areas into the map. All such identified frontiers are added to a frontier list. Discontinuities in depth as determined by jumps in sensor measurements are classified as “rifts.” Such rifts are also added to the list of frontiers to be processed at any point in time.

These disjoint frontier boundary neighborhoods are then characterized by a centroid location, which is used as the goal location for global path planning. Additionally, an approach direction is associated with each frontier. This approach direction is chosen as the normal to the frontier in such a way that it splits the unseen area beyond the frontier into roughly two equal halves. To prevent the robot from repeatedly attempting to explore a frontier goal, in cases where no path to the goal exists, a blacklisting table is incorporated.

After repeated failure of local path plans causing the robot not to reach a frontier, the frontier is blacklisted for a certain period, during which the robot is free to explore other frontiers. It is expected that exploration of other frontiers in the neighborhood potentially clears the cost map or adds paths that enable reaching the previously backlisted frontier.

The autonomous mapper is operative in one or more embodiments to cause the robot to retry the blacklisted frontier once the timeout on the blacklist expires and it is dropped from the blacklist. During a retry, the robot may or may not approach the originally blacklisted frontier along the same original route, depending on the current position of the robot.

The choice of which of the frontier goals/waypoints is to be explored next is decided by the output of the multi-objective optimization.

Global Waypoint Estimation—Objectives for Optimization

The various objective functions ƒᵢ(x) that are to be optimized in one or more example embodiments include: (1) a Distance to Goal objective, (2) an Exploration Potential at Goal objective, (3) a Map Coverage objective, (4) a Map Consistency objective, and (5) a Kino-dynamic Priority objective. Note that these objectives are functions of the frontier goal/waypoint and normalized such that they contribute equally to the optimization (framed as a minimization). Additionally, objectives that are to be maximized are represented as negated objective functions in the minimization problem.

Distance to Goal Objective: Frontier goals that are close enable the robot to arrive faster resulting in quicker exploration. For any given goal, the shortest distance to the goal is computed using Dijktra's shortest path algorithm on the current map. Additionally, for every heading change along the path (i.e., deviation from straight line path), the time taken for making that heading change (based on max angular velocity of the robot) is estimated and converted to a distance offset that is added to the objective function. As shown in equation (4), it is multiplied by max linear velocity and added as a distance offset. This ensures that the distance metric also represents the time taken to reach the chosen goal. The computed distance is then normalized using an expected maximum value for the given space. This maximum value can be a best guess value (user determined, say from a rough estimate of the diameter or diagonal distance of the bounded space to be explored, or computed as a mathematical expectation of maximum distance to goal values for prior runs in the space, as reported by the exploration analytics. The distance-to-goal objective is to be minimized:

$$f ( x ) = [ minDist ( {x}_{c} , r ) + v * ( \frac{{\sum }_{i} \vert {δθ}_{i} \vert}{ω} ) ] \qquad ( 4 )$$

Where minDist is the Dijktra's shortest distance between the centroid xc of frontier x and the current position of the robot r, defined in terms of 2D pixel coordinates (x, y), ν is the maximum linear velocity of the robot, δθᵢ are heading changes along the shortest path, ω is the maximum angular velocity of the robot.

Exploration Potential at Goal: There are two sub-objectives that are categorized as the “Exploration Potential at Goal” objective; namely, a “Frontier Span” sub-objective and a “Frontier Adjacency” sub-objective. These sub-objectives also help increase exploration coverage for any given environment.

Frontier Span: For a given frontier, the span of the frontier specifies how big the frontier is and how much space can be explored by visiting this frontier. The span is calculated as the number of pixels along the length of the frontier, multiplied by the cell/pixel distance (Manhattan distance) between the pixels corresponding to the two ends of the frontier in the occupancy grid of the map (pixels from start and end of each frontier are determined from a bounding box of frontier pixels). It can be expected that such a metric captures the expanse of the unseen area beyond the frontier while discounting for non-smooth features along the length of the frontier. Frontiers that are closer and provide a large area to explore are preferred during the initial phase of the mapping. As with the “distance to goal” objective, this objective is normalized by a large expected value. This objective is to be maximized. Since the multi-objective optimization problem is framed as a minimization problem, the negative of this objective is used as the objective function.

$$f ( x ) = - ( {\sum }_{i ∈ BB ( x )} I ( {x}_{i} , {y}_{i} ) ) * ‖ BB ( {x}_{s} , {y}_{s} ) - BB ( {x}_{e} , {y}_{e} ) ‖ \qquad ( 5 )$$

Where I(xᵢ, yᵢ) is an indicator function for a perimeter pixel i (of the frontier) evaluated across the length of the frontier, BB(xₛ, yₛ), BB(xₑ, yₑ) are start and end points of the bounding box of the frontier x: BB(x).

Frontier Adjacency: It is also possible that there are multiple frontiers in a given area that can potentially merge or lead to unseen areas that merge once one of the frontiers is explored. Thus, the proximity to other frontiers also caters to the exploration potential of a goal. For a given goal/waypoint, this metric is computed as a shortest path search between frontier goals using Rapidly Exploring Random Trees (RRT*), for every other frontier goal in the close vicinity of the chosen frontier goal. The choice of RRT* here (as opposed to the conventional Dijkstra's for global planning) allows for the possibility of computing distance through unseen space. The normalized distance objective is to be minimized.

$$f ( x ) = {\sum }_{n ∈ N ( x )} minDist ( {x}_{p} , {n}_{q} ) , p , q s . t . ‖ p - q ‖ = {min}_{p , P ∈ x , q , Q ∈ n} ‖ P - Q ‖ \qquad ( 6 )$$

Where N(x) is the set of frontiers in the neighborhood of the frontier x, i.e., frontiers that are within a specified maximum distance from frontier x. Here all distances including minDist are calculated using RRT* shortest distance, xₚ, n_{q} are locations of pixel p in frontier x and pixel q in frontier n where p, q are the closest pixels among all pixels in x and n respectively.

Map Coverage: The Map Coverage objective attempts to improve coverage of the map (i.e., fraction of mapped area with respect to the total area to be mapped). It depends on the availability of a floor plan, user sketch, CAD prior or a map of the environment in a prior state, which has since been modified, that may or may not be possible for a specific environment. Hence, this objective is optional. In the case of autonomous re-mapping of a previously mapped environment, the previous map can be reused for the purpose. In such a case, a graph based discretization of the search space is carried out, i.e., the entire environment map is represented as a graph. Topological refinement methods on the graph, such as tessellation, graph and tree pruning are applied to reduce the complexity of the graph and simplify its representation in terms of the graph nodes that form waypoints. Fewer nodes are generated for large areas and more nodes in smaller, compact, and highly structured areas to preserve the topology of the space. Each node is associated with the area that it “covers.” From the list of graph nodes that are in unseen areas, the ‘nodal area’ metric corresponding to the nearest node for each frontier goal is used as the metric for map coverage. Nodes with larger nodal area are to be preferred. This normalized coverage objective is to be maximized.

$$f ( x ) = - NA ( m ) , m s . t . ‖ m - {x}_{c} ‖ = {min}_{m , M ∈ G ( u )} ‖ M - {x}_{c} ‖ \qquad ( 7 )$$

Where NA(m) is the nodal area covered by the graph node m. This node m is the closest node in the graph to the frontier centroid x_{c}. The graph G(u) to which this node m belongs, is the subgraph representing the unseen space in the graph representation of the entire map.

Map Consistency: The Map Consistency objective attempts at improving consistency of the map, i.e., repeatable between successive measurements being generated by SLAM at each time step. A measure of map quality is the repeatability of the generated map. The SLAM process measures map consistency in terms of the entropy measure. Consistently high entropy indicates poor consistency, i.e., the map representation varies significantly between time instances and is inconsistent. Entropy can be lowered by visiting known or seen areas of the map. Localization score is also a related metric, which improves with reduced entropy and declines with higher entropy. Hence, the tradeoff here can be described in terms of an explore-exploit paradigm. There are three sub-objectives that are together categorized as ‘map consistency’. These objectives are gated by a binarized version of the entropy metric E (entropy higher than a threshold activates the objectives, i.e., the gating priority of this objective i in the multi-objective optimization. pᵢ=1, while entropy lower than a threshold deactivates the objectives, i.e., p₁=0).

$$E = - {\sum }_{i ∈ M} p ( {x}_{i} ) {log}_{10} p ( {x}_{i} ) \qquad ( 8 )$$

Where p(xᵢ) is the probability of occupancy of map M's cell i at location xᵢ.

The Map Consistency Objective may be considered to include three sub-objectives: Structure Adjacency, Exploitation, and Predictive Closures.

With the Structure Adjacency sub-objective, frontier goals that are adjacent to physical structures (and not open areas) are to be preferred. More visible structures help localize the robot better and improve consistency and visibility of the map. A metric derived from the distance transform (normalized) at a goal waypoint on the current binarized and value-inverted SLAM occupancy map (goals with nearby structures have lower distance on this metric) serves as the objective to minimize.

ƒ(x)=distXform(x_{c}) (9)

Where distXform(x) is the distance transform of map grid point—frontier centroid x_{c}.

According to the “Exploitation” sub-objective, frontiers which require the robot to travel through and observe seen areas (more exploit and less explore) are preferred, when the entropy drops. This is characterized in terms of a binary objective that re-weights goals farther than a minimum threshold distance positively unlike goals closer than this threshold. Note that this objective is in opposition to the Distance to Goal objective and needs to be maximized.

ƒ(x)=−I(∥x_{c}−r∥>D₁) (10)

Where I(x) is an indicator function, x_{c} is the centroid of frontier x and r is the current robot pose, D₁ is the distance threshold.

The third sub-objective, Predictive Closures, is targeted at identifying frontiers which if the robot travels through, can potentially close a loop back into an already visited area with stable landmarks. In other words, the goal is to choose a frontier that results in a SLAM loop closure. Such a loop closure can then improve the quality and consistency of the map, by providing a correction to the drift in localization of the robot during the mapping process. The “Predictive Mapping” section herein describes details of the prediction process required to identify such paths. Frontiers that are predicted to trigger a loop closure are given a negative distance metric while frontiers that do not are not. This objective is to be minimized.

$$f ( x ) = - I ( minDist ( {x}_{c} , {m}_{q} ) < {D}_{2} ) , \\ q s . t . ‖ {x}_{c} - {m}_{q} ‖ = {min}_{q , Q ∈ M ( o )} ‖ {x}_{c} - Q ‖ \qquad ( 11 )$$

Where I(x) is an indicator function, x_{c} is the centroid of frontier x, D₂ is the distance threshold, me is the location of the cell q of the submap M(o) of the occupied cells of the map M obtained using the current SLAM occupancy map of environment, that is closest to frontier centroid with the distance metric being computed on M augmented with the predicted map, using Dijkstra's (for seen/predicted space) and RRT* (for unseen space) shortest distance.

The Kino-dynamic Priority objective attempts at choosing frontier goals that result in smoother trajectories for the robot to follow. Kino-dynamic prioritization is dependent on the drive system of the robot. While omni-directional drive systems (with mecanum wheels) are minimally affected by changes in direction or speed, differential, car-type, 4WD, synchro drive robots, robots with caterpillar treads, skid/slip steering undergo significant stress to the motors each time a change in direction, speed or acceleration takes place. Choosing smoother trajectories along momentum directions on the continuum field in the local neighborhood of the robot can reduce mechanical stress. This can also result in paths that need reduced power. The metric for characterizing this objective is absolute deviation in direction, as measured in 2D from current position and heading of the robot to that of the frontier, along the shortest path to the frontier centroid. The scan-matching module from SLAM returns gradients that can be also used for this estimation. The normalized objective is to be minimized.

$$f ( x ) = {\sum }_{i} \vert {δθ}_{i} \vert , {θ}_{0} = {θ}_{r} , {θ}_{f} = {θ}_{x} \qquad ( 12 )$$

Where, δθᵢ=θᵢ₊₁−θᵢ are heading changes along the shortest path for each step i, θ₀ is the initial heading and θᵣ is the robot heading at the point of computation, θ_{ƒ} is the final heading and θₓ is the heading at the frontier centroid to be achieved.

These multiple objectives can be further customized or disabled by the user for specific use cases. As mentioned earlier, the multi-objective optimization calculates the solution—the frontier x (identified by its index) that minimizes the scalarized form of the objectives.

### Dynamic Trajectory Generation—Local Refinement

As mentioned earlier, position variables from the global waypoint estimation are further refined by a local step that determines local position and direction. This local refinement step also runs independently at regular intervals refining the local trajectory between global waypoints. The timing relationship between the global multi-objective optimization and local refinement steps is also captured in FIG. 2. The exact nature of the refinement in an example embodiment is described below

The local refinement step helps improve local map completeness. This is achieved through two modules: a Scan Counting module and a Next-Best Views module.

Scan counting: The scan counting module ensures each structural component placed in the map is estimated with sufficient confidence in observation. In other words, it ensures that there have been a sufficient number of view rays that have impinged on a cell in the map and identified it as an obstacle or passed through it, hence identifying it as a free cell. If the threshold criteria is unmet, additional waypoints and directions are sent to the global planner to obtain additional scans, before continuing with the global waypoint.

Next-best views: The Next-Best Views module ensures that local structures are completely mapped. This enables local consistency of map structures by creating waypoints, paths and directions that facilitate this. An example of such a trajectory is moving in a circle around an object to complete its visual description. This is performed by creating a convex hull of the visible structure under consideration and moving around the hull along a diversion path, to the extent that the path distance does not exceed a maximum deviation from the global path to the current frontier goal at the point of deviation. The convex hull is updated as the exploration progresses, and the map gets updated by SLAM. If the maximum deviation is reached, waypoints that return the robot to the global path to the frontier are generated. On the other hand, if exploration around the convex hull is complete, the robot will have already returned to the global path. As with scan counting, these additional waypoints and directions around the hull are sent to the global planner and once the visual description of the local structure is complete, processing of the current global waypoint continues.

Exploration Suite—Static Trajectory Generation

Several static user-defined waypoint generation behaviors are also provided as options for trajectory generation. These include: (1) pre-defined user-specified landmarks and/or trajectories that the robot needs to visit/follow, only avoiding local obstacles; (2) wall following by maintaining a stand-off distance from a starting wall, succeeded by looping of inner regions (away from walls) with only odometry to guide the robot—this behavior is suitable for mapping in environments that are extremely sparse and devoid of features; and (3) spinning behaviors for extremely quick mapping of small rooms with minimal clutter.

Such static trajectories can be used in place of dynamic trajectory generation in specific use cases. Goals/waypoints generated from these user-defined trajectories are also sent to global planner for further processing.

Exploration Suite—Predictive Mapping

Predictive Mapping is proposed as a technique for enhancing the “Map Consistency” objective. The goal here is to be able to predict how the environment beyond a chosen frontier looks so that it is possible to determine if a loop closure can be triggered by taking a path through the frontier and finding a route that returns to a previously observed section of the environment with stable and reliable landmarks.

When operating in industrial spaces or other large environments, it is likely for robots to encounter similar or repeated structures. This is especially true of warehouse aisles and docks. A Generative Adversarial Network (GAN) with generative and discriminative components is used to train on scenes in the environment already visited and predict the next possible structural shape that completes the map in the path of the robot. For example, the predicted shape in a warehouse could produce a structure that has a loop back path at the end of an aisle. The generator produces map sections using the SLAM instantaneous map and map prior sections during the training phase, while the discriminator is trained to identify if such a generated map is different from prior full maps in an unsupervised manner. This architecture is shown in FIG. 4.

With successive rounds of backpropagation learning, the generator gets better at creating maps that the discriminator cannot flag as different from map priors, while the discriminator gets better at flagging such maps. During inference, the SLAM instantaneous map is used to generate a predicted map beyond the frontier. The GAN prediction of likely loop closure enabling structure in a particular direction (determined by finding the shortest path using Dijkstra's to known map points) downstream from the robot's current position is used as an objective in the optimization problem when loop closure might mitigate a dropping localization score or rising entropy. GAN predicted directions not resulting in loop closure are ignored in such context.

Note that the training process for the GAN can be offline (based on prior maps in similar domains/environments—such as industrial warehouses or supermarkets), domain adaptation might be necessary for specific use case environments and is performed online. This requires additional compute. On the other hand, inference has a lower computational cost due to the localized nature of the prediction. Furthermore, when training and inference are performed using a simple binarized representation of the SLAM generated maps, the computational complexity is kept low.

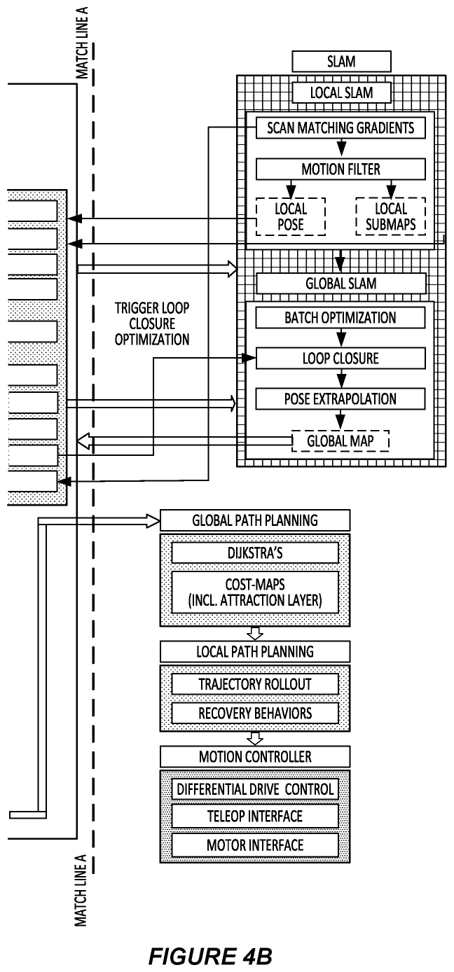

This novel approach is termed “Predictive Mapping” in this disclosure and as mentioned earlier, the Predictive Mapping module is helpful with loop closures. When entropy is above the threshold and there is an increasing chance of localization errors or increase in the error uncertainty, the inference stage is applied so that the robot can track a path leading to loop closure, at which point such errors can be reduced or eliminated from the system. This mechanism is also captured in FIG. 1 and corresponding timing behavior in FIG. 2, and FIG. 5 illustrates an example GAN configuration for loop closure prediction—i.e., implementation in the Predictive Mapping module.

Exploration Suite—Stopping Criteria

Various stopping criteria for exploration performed by the autonomous mapper are also provided. An example set of such criteria includes any one or more of: physical bounds set a priori by the user, virtual bounds set a priori by the user using the user interface, spatial scaffolding (user marking of boundary limits for exploration), parameterized definitions for frontiers and scaffolding structures, frontier size restrictions (minimum and maximum values), limits on exploration time, limits on wander distance (distance from base a robot is allowed to travel), threshold restrictions (whether the robot is allowed to navigate through a potential doorway—into a new room), and source to sink behaviors (wherein a robot stops exploring once it reaches a sink target—landmark targets such as docks or image targets).

### Global Path Planning

The main component of the global path planning module is a shortest path estimator based on the Dijkstra's algorithm, which is used here to find the shortest path towards a specified goal or waypoint while avoiding obstacles in the SLAM map. Details of how these goals are specified is discussed in the section on the Exploration Suite. Unlike the distance computation in the exploration suite that uses the Dijkstra's on the SLAM generated map, the global path planner uses additional constraints on the shortest path computation, specified in the form of cost maps. Four layers of cost maps, projected on to a single 2D cost map are used to characterize obstacles that need to be accounted for, while computing the global path. Regarding general cost map examples, see Wang, X., Mizukami, Y., Tada, M., & Matsuno, F. (2021), “Navigation of a mobile robot in a dynamic environment using a point cloud map,” Artificial Life and Robotics, 26(1), 10-20.

The first of the four layers is a 2D “static” occupancy grid layer created from the SLAM generated map (which is also updated dynamically as part of the mapping operation). The obstacles in this layer are absolute and the global path planner must avoid obstacles in this layer mandatorily.

The second layer is a “dynamic” 3D voxel grid layer created from point cloud data from ranging and other landmarking sensors, which are positioned at different heights on the robot. This dynamic layer is cleared periodically to allow for transients in the scene content, such as humans walking through the environment, while accounting for sensor characteristics such as reliability, frame rate and noise performance.

The third layer is a 2D “inflation” layer that grades the distance to obstacles on a curve. In other words, a higher cost is associated with cells in the cost map that are closer to obstacles than those farther away. This forces the robot to keep away from obstacles, while allowing it to approach close to these obstacles in cases where no minimal cost paths with large standoff or clearance can be found. In such cases, only high cost paths with small clearances may be available and these are executed by the local planner at low speeds, reducing the possibility of collisions and e-stops

The final layer is a 2D “attractor” layer that enables the robot to “hug” obstacles during navigation (for wall following behaviors). The attractor layer prevents the robot from getting lost in wide open areas and works selectively on large obstacle structures such as walls and also forces to robot is stay within the confines of the environment. The visibility of the current environment and its correspondence to the known SLAM map is estimated by a map entropy metric. When the map entropy metric has high values—indicating lack of correspondence between observed environment and current state of the map, the global planner uses the 2D attractor layer to re-weight the cost map to choose paths that prevent or reduce complete loss of localization during the exploration process.

The static layer is the most significant component for global path planning, while the dynamic layer is the most important for local path planning behavior. The inflation layer allows for suboptimal paths where no optimal paths are found, by allowing the robot to get close to obstacles at lower speeds. The attractor layer ensures that the robot does not get completely lost during the exploration process. Hence the inflation and attractor layers work in juxtaposition for large structural obstacles in the environment.

Local Path Planning

The local path planning module is the component responsible for generating potentially kino-dynamically feasible behaviors while avoiding collisions. It performs computations within a limited spatial range around the current position of the robot and uses a polynomial model based particle simulation to establish local trajectories. The goal of the local planner is to produce simplified paths that can be actuated by the robot's differential drive motors, while allowing the robot to follow a path that is as close as possible to the global path and at the same time, avoiding any local obstacles.

Two possible conventional algorithms are incorporated here—Dynamic Window Approach (DWA) and Trajectory Rollout (TR). In general, TR provides better results with exploration since it samples from the set of achievable velocities over the entire forward simulation period as opposed to DWA which samples only for one simulation step. Both algorithms work by forward simulating particle trajectories along polynomial curves and determining if a collision occurs at each step of the simulation. A search for the most optimal path (as per the cost maps) without collisions is performed and such a path is chosen as the trajectory for deployment and implemented using a velocity controller.

Recovery Behaviors for Local Path Planning

Several recovery behaviors are also implemented to prevent the robot from potentially getting and being stuck in cluttered environments. These include alteration to cost maps, and incorporation of spinning behaviors, backtracking and U-turn behaviors as examples.

Example cost map alterations include: (1) periodic clearing of the dynamic cost map (note that the dynamic cost map layer is the most severely affected by transients in the environment that might obstruct the robot and prevent it from following its path (such as a human or group of humans in the path of the robot), and, consequently, clearing the dynamic cost map periodically helps remove these transient obstacles from the cost map once they have moved away from the obstructed field of view; (2) adjusting gradient weights of the inflation layer (gradient weights of the inflation layer in the local vicinity are given reduced weights permitting additional paths to allow for the robot to steer clear of the obstruction, including those paths that might take the robots close to known obstacles; and (3) disabling of the attraction layer (the attraction layer is disabled when the robot is steering clear of obstructions, so as to avoid further motion towards obstructions).

Example local planning behaviors include any one or more of: (1) a spinning behavior that is useful when the robot is obstructed in one or more directions but has at least one approach vector out of the current position (using the spinning behavior allows the robot to find the exit direction and leave the obstructed area); (2) a backtracking behavior that is useful when there is a loss of localization or severe sensor obstruction—in such cases, the robot unwinds its trajectory, i.e., returns back along the path it had taken to get to the current position and tries to improve its localization accuracy before attempting an alternate route to the goal waypoint that avoids the obstructed area; and (3) a U-turn behavior that requires the robot to turn around in position and drive to reach a previously visited waypoint before continuing towards its goal (while backtracking assumes the robot wheels are turned in the reverse direction, U-turn behaviors require the robot to turn around in position and that behavior is suited for obstacle avoidance over longer distances).

Combinations of the foregoing recovery approaches are used in different contexts, guided by sensor observation of the current state of the environment. Spinning behaviors are the most efficient and hence are most often used.

Motion (Velocity) Controller

A velocity controller is incorporated into the autonomous mapper system to translate paths chosen by the local path planner into velocity commands. The standard velocity-acceleration-distance relationship

S=u(tₙ−t₀)+½a(tₙ−t₀)²

where S is the displacement in the trajectory, u is the initial linear velocity of the robot, a is the acceleration of the robot and t₀ and tₙ are initial and final times over which the control is applied, is used to dynamically adjust velocities by the controller to reach desired trajectory points. The linear and rotational velocities are converted into radial, tangential velocities for the differential drive wheels. The velocity commands are sent to the motor drivers onboard the robot.

### SLAM for Map Generation

An online SLAM backend is used for the generation and update of a map for the representation of the current state of the environment. One or more embodiments use filtering approaches rather than graph based approaches to SLAM, where these approaches are implemented to support an online mapping mode. Additionally, predictive mapping takes advantage of loop closures in SLAM. The occupancy map generated by SLAM is also used to identify frontiers and for global/local path planning. The scan matching in SLAM can also potentially deliver gradient directions for kino-dynamic prioritization. Hence, this module runs continuously and in parallel with exploration suite, as well as with other planning and actuation modules.

User Interfaces

The autonomous mapping system also provides for user interaction in the form of four user interfaces that are active at various times of the execution of the system.

These include interfaces for (1) Exploration Customization, (2) Live Feedback and Exploration Control, (3) Offline Map Feedback and Map Edit Tools, and (4) an Analytics and Recommendation System.

Exploration Customization: This interface provides for customization of exploration parameters and constraints prior to the execution of the exploration run.

Live Feedback and Exploration Control: This interface provides live feedback on the exploration process to the user during the exploration run and lets the user to monitor and control the run.

Offline Map Feedback and Map Edit Tools: Once an exploration run is complete, this interface displays the final map to the user and allows the user to edit it.

Analytics and Recommendation System: This interface presents a summary of the exploration run, presenting analytics and evaluation of key metrics from the run. It also includes a recommendation system that advises the user for customization/adaptation of future exploration runs.

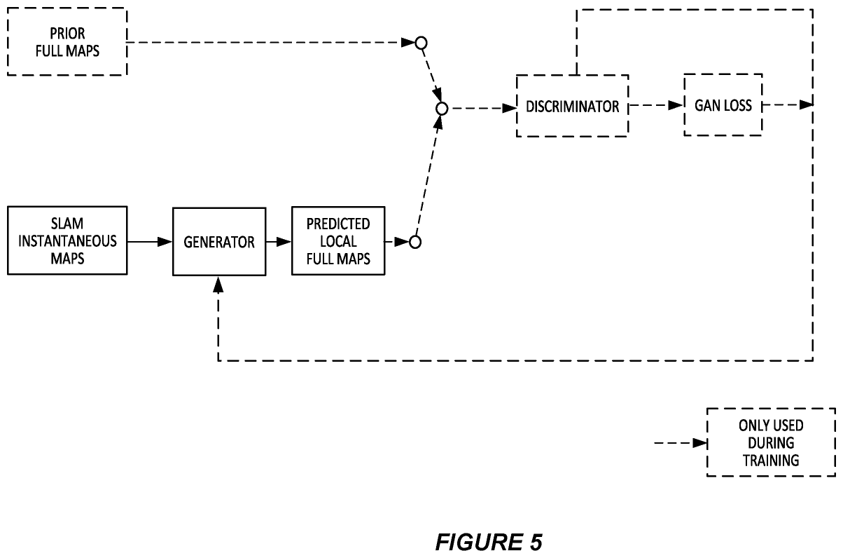

FIG. 6 depicts a state diagram of exploration in relation to the foregoing interfaces.

User Interface—Exploration Customization

The Exploration Customization interface presents various options that the user can select/tune prior to the start of the autonomous mapping process. These include termination criteria in terms of any one or more of limits on exploration time, wander distance (distance from base a robot is allowed to travel), frontier size restrictions (minimum and maximum values), threshold restrictions (whether the robot is allowed to navigate through a potential doorway—into a new room), spatial scaffolding (user marking of boundary limits for exploration), and source to sink behaviors (wherein a robot stops exploring once it reaches a sink target—landmark targets such as docks or image targets). Additional or alternative criteria may be specified in other embodiments.

The Exploration Customization interface also offers users the option of choosing various static path behaviors—for example, wall following (succeeded by loop of inner regions with only odometry) for operation in environments that are extremely sparse and devoid of features and spinning behaviors for extremely quick mapping of small rooms with minimal clutter.

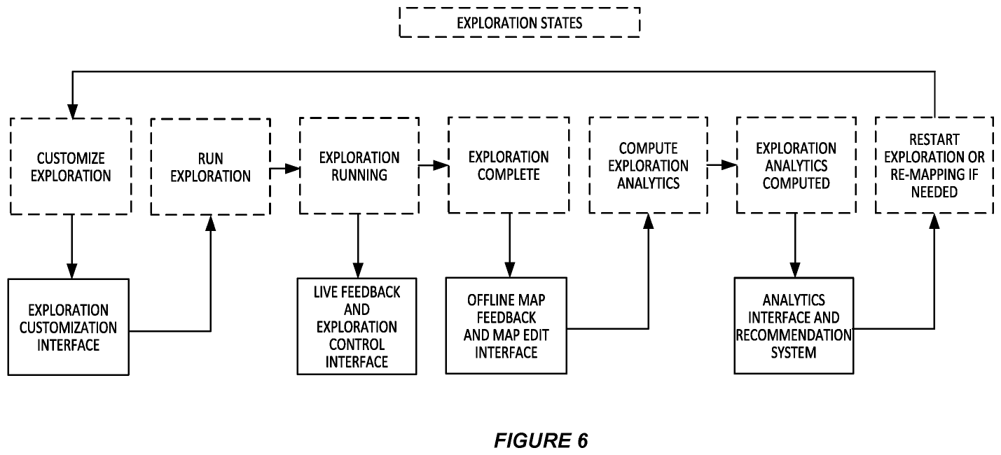

The user interface is also designed to support various parameter tuning options to safely explore real-world unpredictable environments. User interface options for fixed trajectories are also presented with adaptations for sparse featureless environments. In terms of exploration strategies, the user interface also presents options for minimum frontier dimensions to consider, distance to frontiers, priorities for frontiers etc. Additionally, options for weights and parameters for the multi-objective global optimization and local refinement are also presented. A simplified representation of an example interface for user customization is shown in FIG. 7.

Note that the “interface” at issue is realized via underlying processing circuitry generating the display data, receiving user input, etc., and the display may be included on the robot or may be external, such as included in a laptop computer or other computing system. The program instructions that provide the user interface may be executed in part or in whole onboard the robot, e.g., with an attached laptop or other display system used as a terminal, or the attached computer may run the code that provides the visual display, with the autonomous mapper running complementary computer code that allows it to send current settings, receive adjusted settings, etc.

User Interface—Live Feedback and Exploration Control

The user feedback interface provides real-time feedback during the autonomous mapping process. In addition to providing the current map of the environment in the form of an occupancy grid the real-time interface displays the current position of the robot, the obstacles as detected by on-board sensing—lasers, sonars etc., local, and global cost maps for path planning, the locally planned path, the globally planned path and most importantly, frontiers that the autonomous mapping will explore. These frontiers are also ranked by their priority in which they are to be visited. Blacklisted frontiers are indicated in a unique color. The interface also provides options to reorder or increase/decrease the priority (by clicking on corresponding buttons in the screen display) in which the frontiers will be visited. Additionally, users can click on a checkbox to blacklist or whitelist a frontier. Active/inactive frontiers (blacklisted either manually or automatically by the blacklisting table) are also presented to the user. Automatically blacklisted frontiers might become active again after the end of a blacklisting period.

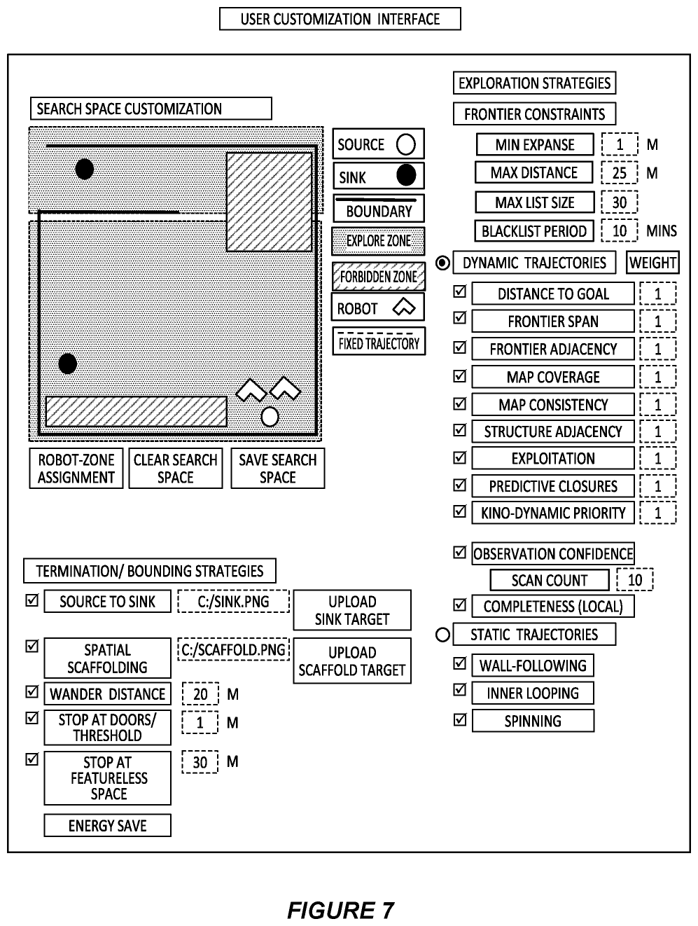

Prompts are also available to enable a user to abort exploration when they anticipate a risky or unsafe maneuver on the part of the robot. The prompt is also useful when the robot enters a region or takes a path that shouldn't be mapped or navigated by the robot. In such a case, setup of spatial scaffolds or barriers is expected, at which point the user can resume mapping by selecting the prompt again. Additionally, the prompt can be used to terminate the autonomous mapping process and complete the map generation, when the user determines that the necessary mapping coverage of the environment has been obtained and is sufficient for navigation during task phase operation. A prompt is also provided to rollback recent trajectories traversed by the robot for mapping. Like the abort prompt, this is useful when the robot enters a region or takes a path through an environment that shouldn't be present in the final map. The rollback trajectory prompt allows the user to rollback an arbitrary number of paths starting with the most recent path. During the rollback operation, the robot backtracks along the paths taken reaching start locations of these paths iteratively. The map sections added during these paths are also removed from the current map. A simple representation of the user feedback interface is shown in FIG. 8.

User Interface—Offline Map Feedback and Map Edit Tools

Providing manual map editing tools via the user interface serves at least two purposes. Firstly, maps generated using the automated mapper can be refined using the manual map edit process. Any sections missed by the autonomous exploration can be added in, as part of the map edit process. The map edit tool allows the user to specify missed boundaries. The boundaries are defined in terms of polygonal vertices which are specified by clicking on the map visualization interface. Furthermore, sections of the environment mapped independently by different robots, with or without overlaps can be merged using the map edit tool. The map edit tool provides options to translate and rotate maps to bring them in to the same global coordinate system and align various structures in the maps. Merging of maps is also a useful feature to take advantage of maps generated during different times. For instance, while a map corresponding to a large environment is mapped once, a particularly busy room might need to be remapped periodically. The map edit process helps overlay a more recent version of the room on top of the existing base map and align with preexisting structures, thus eliminating the need for a full remap of the environment.

Also, once the refined map is available, it can be used to evaluate and tune the performance of the autonomous mapper. In this context, the refined map serves as a ground truth against which the map from the autonomous mapper is compared, to determine the coverage of the mapped environment. For instance, the minimum size of wavefronts to be explored can be reduced if bottlenecks corresponding to the minimum size are identified in unexplored regions with respect to the ground truth (such as narrow corridor entrances).

### User Interface—Analytics and Recommendation System

In addition to feedback available in the form of the map for editing, the following measurements and state variables are obtained/calculated in one or more embodiments, to generate evaluation criteria, profiles for operation and statistical measures for exploration analysis and optimization as an offline process. Based on these values, presented to the user via the user interface, additional exploration runs in the same or similar environments can be preconfigured suitably by the user, as per the recommendations made for each metric.

The autonomous mapping analytics user interface enables access to any one or more of the following metrics, which are broadly referred to herein as “exploration analytics”: power usage, power draw, coverage rate, boundary detection rate, entropy, odometry x-y, odometry theta, twist linear, twist angular, global plan triggers, global plan neighborhood triggers, local plan neighborhood triggers, goal x-y, control goal acceptance delay, command velocity linear, command velocity angular, control feedback pose x-y, control feedback pose theta, and frontier counts. Details of such exploration analytics are as follows.

Power Usage—This metric/curve describes power usage with time/coverage as measured from robot battery interfaces through the exploration run. This helps minimize battery usage up to the point of exploration convergence. If the user wants to reduce battery usage, they might want to adapt the point of exploration convergence/termination (time, distance or frontier distance and size stopping criteria) since robots can spend considerable amount of time in regions between 90% and 100% coverage.

Power Draw—Similar to the power usage metric, this is measured from robot battery interfaces through the exploration run. Avoiding prolonged high power draw (i.e., rapid drop in voltage) might be necessary as this can be harmful to battery life. User might want to set kino-dynamic prioritization (momentum) weights in the optimization problem suitably to reduce sharp turns and obtain desired behavior.

Coverage Rate—Coverage rate is the primary evaluation modality for exploration. Coverage rate is calculated as percentage of area (m\hat{ }2)/pixels with respect to ground truth map. It is measured across time and is the metric against which other tunable parameters might be benchmarked against. If the final coverage rate is low, the user might want to loosen stopping criteria. Ideally, we want the coverage rate to be close to 100%.

Boundary Detection Rate—Boundary detection rate is calculated as percentage of boundary pixels detected with respect to ground truth map. It is measured across time and provides a supplementary metric to coverage rate. We also want this metric to be close to 100%.

Entropy—As mentioned earlier, increases with discovery of unmapped areas, drops with mapping. If the robot spends an excessive amount in exploit mode (choosing frontiers that require passing through seen space) or looping back, the threshold on entropy can be increased by the user to permit faster exploration.

Odometry x, y—This is recorded using robot odometry interfaces. This helps identify boundaries of explored space and trends in time spent by robot in mapping each area. This is useful to tune scaffolding variables (extents of space to map).

Odometry theta—Similar to (vi). This helps identify trends in typical robot heading for given exploration space. This also identifies the number of turns the robot makes during exploration. This can guide the user to change the weight for kino-dynamic prioritization.

Twist linear—A curve of this variable is obtained from commanded velocities. This helps ensure robot respects maximum linear velocity limit, also helps identify typical velocities and time spent at the velocity, as well as changes in velocity profiles in given space. This might be helpful if the user wants to tune parameters in a space with human and other dynamic obstacles to ensure higher degrees of safety and predictable behavior.

Twist angular—This helps ensure robot respects maximum angular velocity limit during turns, also helps identify typical velocities and time spent at the velocity, as well as changes in velocity profiles and how often the robot turns in given space. User tuning is same as above, but angular twists give a better indication of dynamic obstacles than linear

Global Plan Triggers—This timing data is obtained from the global path planner. This helps identify when new global path plans are available, along with the lengths of each global plan. This also indicates how far off frontiers are. These should be synced with new frontier availability, helps optimize and keep number of additional global plan triggers for each frontier goal low, thus reducing compute cost.

Global Plan Neighborhood Triggers—This timing data is obtained from the local path planner. This helps identify when new global plan neighborhoods (for local path planning to follow) are available and indicates their lengths—longer lengths are preferable since the robot can travel further and faster, cluttered plans are indicative of infeasible global plans and replanning, and hence higher compute loads on the robot. This is indicative of narrow and dynamic spaces. User might want to adapt cost map weights (especially the inflation layer) to allow for tight passes and corners in such situations (perhaps at reduced speed)

Local Plan Neighborhood Triggers—This timing data is obtained from the local path planner. Helps identify when new local plan neighborhoods are available and indicates their lengths—longer lengths are preferable since the robot can travel further and faster, cluttered plans are indicative of infeasible local plans and replanning. Similar considerations to global plans apply, but this variable is impacted to a higher degree by dynamic obstacles.

Goal x, y—This timing data is obtained from the exploration suite. This is indicative of when new and where frontier goals are available and how much time the robot spends in each section of the environment to map frontiers (and hence unexplored regions)

Control Goal Acceptance Delay—This timing data is obtained from the motion controller. This is indicative of complex global and local paths and hence infeasible planned paths and replanning in terms of number of tries before viable path is found. User might want to restrict the number of tries if this metric becomes too large.

Command Velocity Linear—Obtained from the motion controller, this identifies command linear velocities sent by the velocity controller to the motor controllers, ensures robot respects maximum velocity bounds, cluttered points indicate higher stress on motors. User might want to reduce maximum local plan rates and robot speeds to reduce stress on robot motors.

Command Velocity Angular—Also obtained from the motion controller, this identifies command angular velocities sent by the velocity controller to the motor controllers, ensures robot respects maximum velocity bounds, cluttered points indicate higher stress on motors. User adjustment is like the linear case.

Control Feedback Pose x, y—Obtained from motor encoder data, this identifies pose (location) of the robot as estimated by controller, needs to be close to odometry x, y. Differences to commanded can be indicative of slip, user might want to adjust SLAM odometry noise models or modify floor conditions (if possible) to accommodate for errors arising from such deviations.

Control Feedback Pose theta—Obtained from motor encoder data, this identifies pose (heading) of the robot as estimated by controller, needs to be close to odometry theta. User modification is like above.

Frontier Counts—This metric is obtained from the exploration suite. This gives frontier pixel counts, identifies when new frontiers are available (through large values) when the robot reaches a new unexplored room or other space, typical trend should be asymptotically approaching zero with time as the robot coverage of the environment increases. This variable can be useful to the user in determining the maximum frontier size to be explored in a particular environment and hence related stopping criteria.

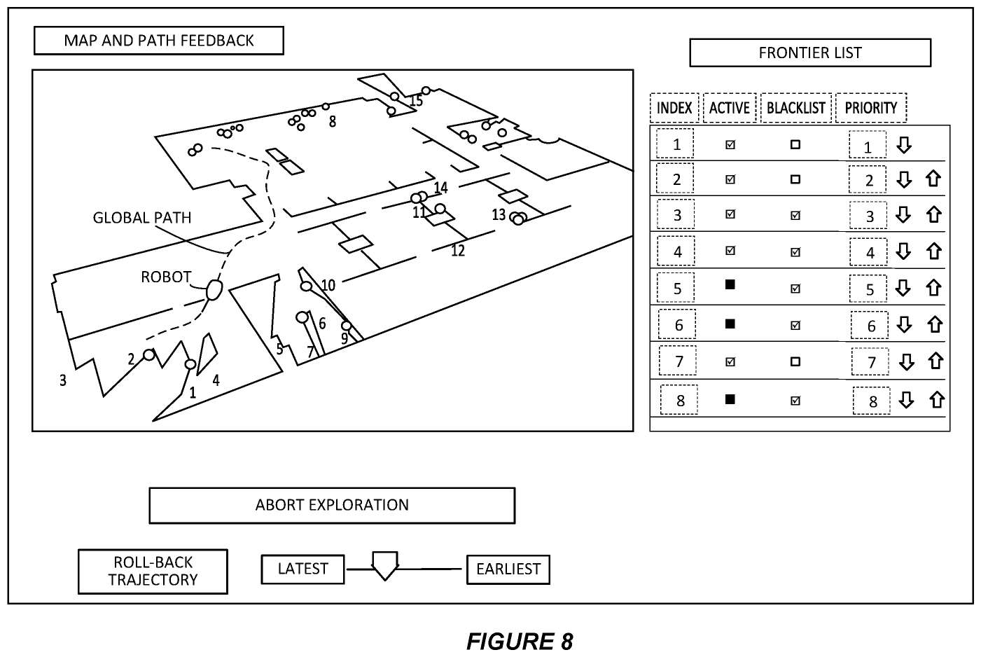

FIG. 9 illustrates a mobile robot 10 according to its constituent entities or sub-assemblies, according to an example embodiment, where the mobile robot 10 includes a control system 12 that provides a run-time environment 14 in which an autonomous mapper 16 is instantiated and executed. As such, the robot 10 running the autonomous mapper 16 may be considered as an example autonomous mapping system, with the autonomous mapper 16 configured or otherwise operating according to any of the above-described “autonomous mapper” embodiments.

The term “run-time environment” refers to the program execution environment provided by control system 12, e.g., one or more microprocessors and corresponding memory, and it may be configured or otherwise controlled by an operating system (OS), such as a real-time OS (RTOS) running on the robot 10.

The robot 10 further comprises a drive system 18, one or more sensor systems 20, one or more interfaces 22, and one or more power systems 24. The control system 12 interfaces or otherwise interacts with these various entities, for overall control and operation of the robot 10. In that regard, the control system 12 comprises fixed circuitry or programmatically configured circuitry or a mix of both. In at least one embodiment, the control system comprises processing circuitry for communicating, or otherwise interacting, with the various constituent entities onboard the robot 10, e.g., the drive system 18, the sensor system(s) 20, etc. In at least one example, such processing circuitry comprises or includes one or more microprocessors or other digital processors that are specially adapted according to the execution of computer program instructions stored onboard computer-readable media, along with supporting input/output circuitry.

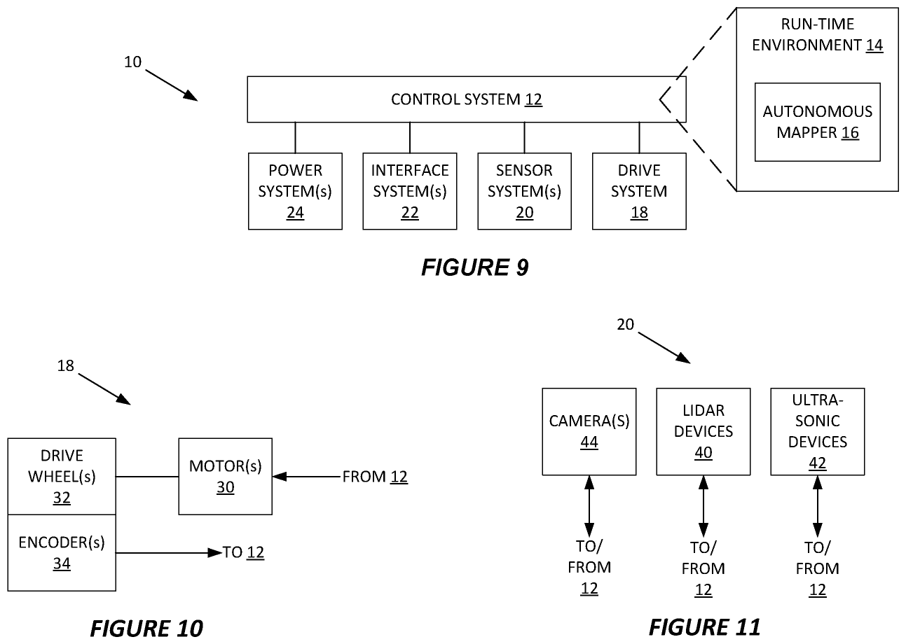

FIG. 10 illustrates an example embodiment of the drive system 18, which includes one or more motors 30 that provide motive power to drive wheel(s) 32. While not shown explicitly in the diagram, the robot 10 may include motor control circuitry that translates motion commands generated by processing circuitry of the control system 12 into corresponding motor drive signals. Such circuitry may be considered as part of the control system 12 or part of the drive system 18 or as bridging circuitry therebetween. The drive system 18 further includes one or more encoders 34, which provide odometric feedback from the drive wheel(s), for dead-reckoning computations performed by the control system 12.

FIG. 11 illustrates an example embodiment of the sensor system(s) 20, which include any one or more of: one or more LIDAR devices 40, one or more ultrasonic devices 42, or one or more cameras 44. These sensors allow the robot 10 to scan or otherwise sense its surrounding physical environment, including obstacles, structures, etc., for autonomous navigation and mapping within that environment. As such, the sensors may be referred to as “environmental” sensors. For example, the LIDAR devices 40, e.g., laser scanners, sweep laser pulses across or through some angular range in a horizontal plane, with the distance of reflecting objects determined based on time-of-flight of the pulse reflections received by the laser scanners. The robot 10 in one or more embodiments has multiple laser scanners positioned at different heights, for more robust, reliable detection of objects in the surrounding physical environment.

FIG. 12 illustrates an example of the interface system(s) 22, including communication interface circuitry 50 for wired or wireless communications. In the example depiction, the communication interface circuitry 50 comprises first transceiver circuitry including first transmitter circuitry 52-2 and first receiver circuitry 54-1, for wired communication, e.g., an Ethernet connection or other computer-data connection. In this regard, the communication interface circuitry 50 will be understood as providing the physical-layer transmitter and receiver circuitry, along with protocol processors, e.g., for implementing one or more communication protocol stacks. Alternatively, processing circuitry within the control system 12 provides protocol processing, with the communication interface circuitry 50 providing the physical layer signaling connectivity.

In an example embodiment, the transmitter circuitry 52-1 and receiver circuitry 54-1 provide a communication link for coupling to a laptop or other external computing device that runs software providing access to the user-interface customization features provided by the autonomous mapper 16.

In at least one embodiment, the communication interface circuitry 50 includes a wireless communication interface comprising a second transceiver that includes transmitter circuitry 52-2 and receiver circuitry 54-2, which interface to one or more antennas 58 via antenna interface circuitry 56. Such circuitry implements a Wi-Fi or other radio communications link, and it may be used for command and control of the robot 10 during live operation and, in at least one embodiment, the wireless interface provides communicative access for user-interface based customization of the exploration behaviors manifested by the autonomous mapper 16.

The interface system(s) 22 may further include control panels, such as touchscreens or other local User Interfaces (UIs) onboard the robot 10, e.g., allowing operators to check status, input commands, etc. FIG. 13 illustrates an example local UI 60, along with an effector 62, such as may be mounted on a robotic arm. Of course, the physical particulars of the robot 10 depend on its intended purpose, e.g., to the extent that it is not dedicated to autonomous mapping operations. For example, the robot 10 may be equipped with a load carrying platform for materials transport, etc.

FIG. 14 illustrates example implementation details for the control system 12. Processing circuitry 70 implements at least some of the processing logic by which the autonomous mapper 16 is realized and it comprises, for example, one or more microprocessors 72 that include or are associated with storage 74 that stores one or more computer programs 76 and supporting configuration data 78. The computer program(s) 76 contain computer program instructions that, when executed by the microprocessor(s) 72 specially adapt them to carry out the processing operations by which the autonomous mapper 16 is effectuated.

The storage 74 comprises one or more types of computer-readable media and provides non-transitory storage of program instructions and data. “Non-transitory” does not necessarily mean permanent or unchanging, and instead means storage of at least some persistence, and the storage 74 may comprise a mix of volatile or working memory and non-volatile memory, and example circuits, devices, or elements include any one or more of SRAM, DRAM, FLASH, EEPROM, Solid State Disk (SSD), etc.

The microprocessor(s) 72 interface with one or more motor controllers 80 that provide drive signals to the motors 30 in the drive system 18, and interface with the sensor system(s) 20 via sensor interfaces 82. Such interfaces may comprise data-bus based interfaces for the exchange of sensor control signaling and sensor data, which may be preprocessed by the sensor system(s) 20. Additionally, or alternatively, such interfaces include discrete analog and/or digital inputs/outputs (I/O). Further, the term “microprocessor” has a broad meaning and encompasses a range of implementations or types, such as microcontrollers, Digital Signal Processors (DSPs), Application Specific Integrated Circuit (ASIC) or Field Programmable Gate Array (FPGA) cores, System-on-a-Chip (SoC) variants, etc.

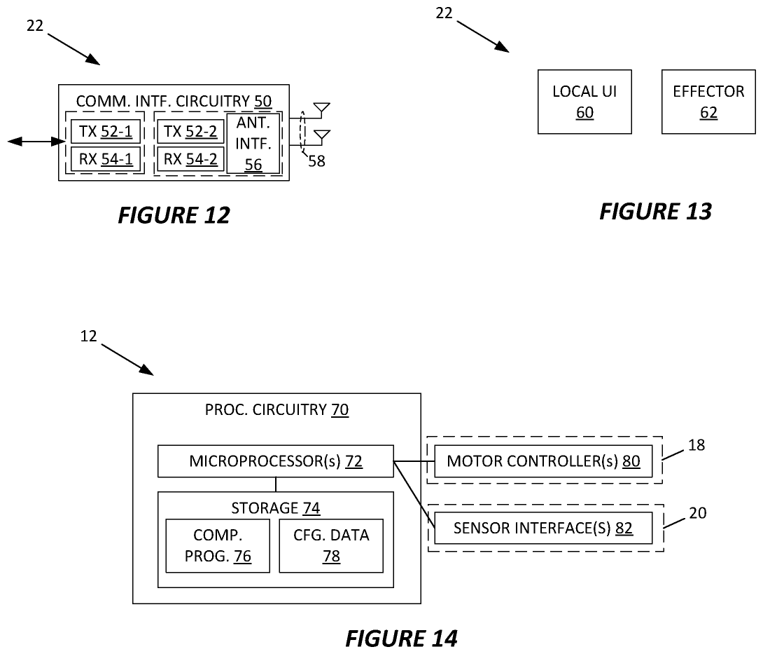

FIG. 15 illustrates an example arrangement wherein a robot 10 implements an autonomous mapper 16 as described herein. An external computer 90 couples to a Wireless LAN (WLAN) 92, which in turn communicatively couples the external computer 90 to the robot 10.

Robot configuration software 100 executing on the external computer 90 provides a user interface 102 for user customization of the exploration behaviors of the autonomous mapper 16, as described in the User Interface portions of this document, above. Here, the robot configuration software 100 either implements the user interface 102 or it provides a terminal function by which a configuration function 104 implemented via the autonomous mapper 16 onboard the robot 10 causes the user interface 102 to be displayed on the external computer 90. In either implementation, the configuration function 104, also referred to as an exposure function, is configured to use modifiable values of corresponding operating parameters that drive the exploration behavior of the autonomous mapper 16, for user inspection and adjustment. For example, the configuration function 104 uses stored values that are determined, modified, prioritized, or weighted based on signaling received through a user interface or derived from user input received via a user interface. Alternatively, the configuration function 104 gets the values from a configuration file or data structure that is loaded into memory or other computer-readable media included in the mobile robot.

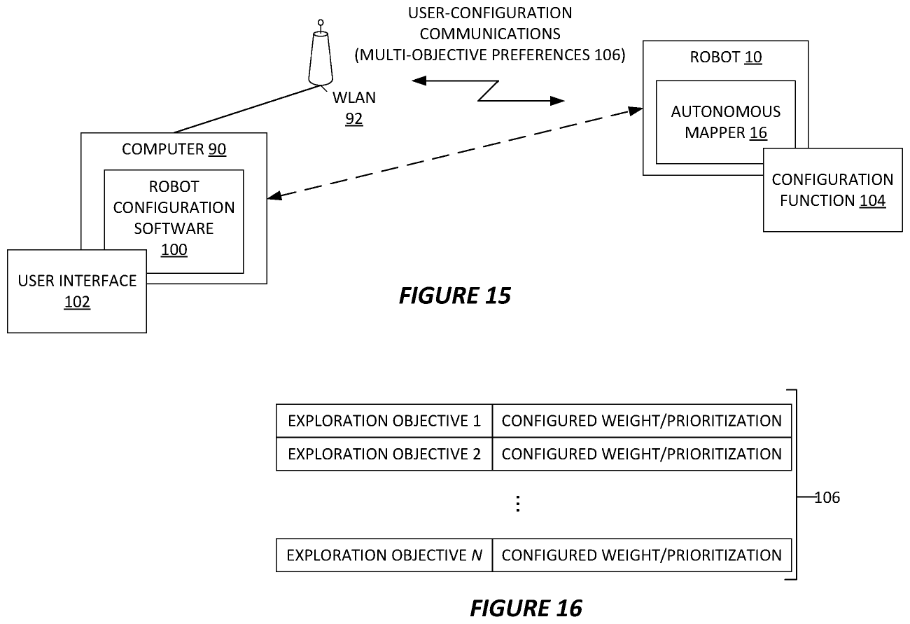

As one example of user customization, the external computer 90 communicates multi-objective preferences 106 to the autonomous mapper 16, where these preferences enable/disable respective ones of the multiple optimization objectives described above, or otherwise assigns a relative prioritization or weighting that control how the multi-objective optimization performs its joint optimization of the multiple objectives. FIG. 16 illustrates such an arrangement, wherein a number of exploration objectives considered in the multi-objective optimizer have corresponding configured weights or prioritizations that are user selectable or adjustable to tailor the exploration behavior of the autonomous mapper 16—e.g., biased towards map consistency or biased towards exploration speed.

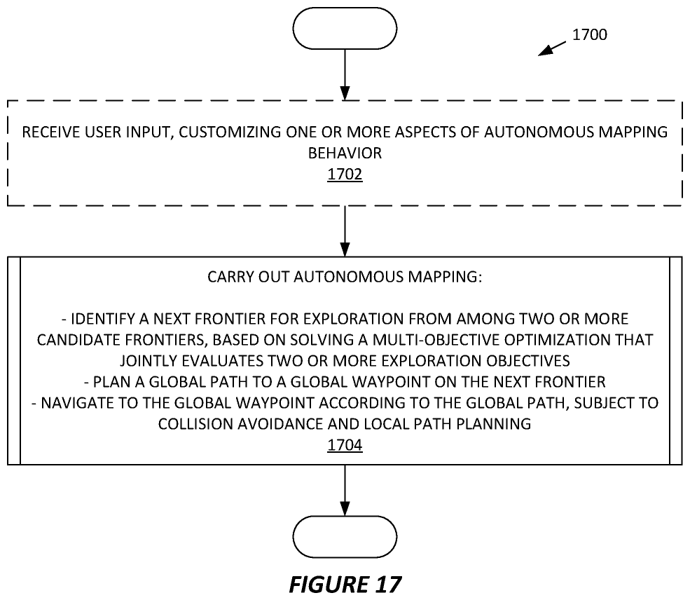

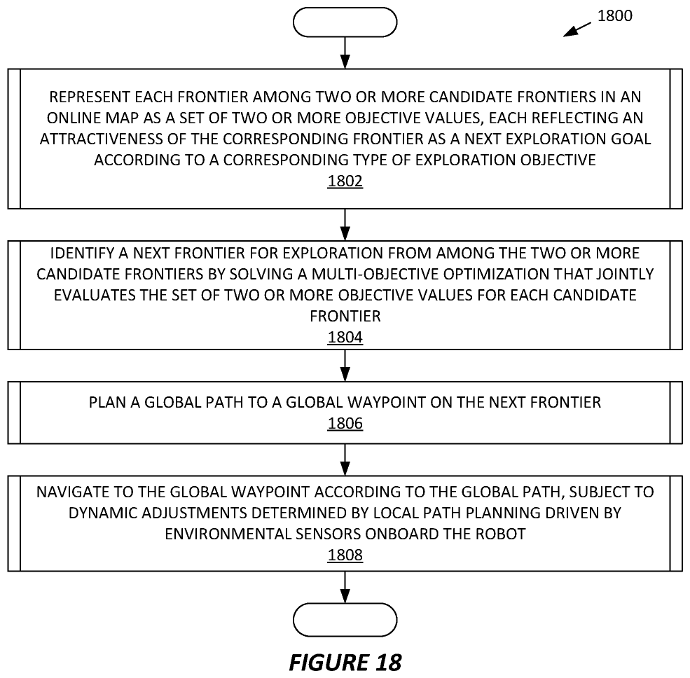

FIG. 17 illustrates a method 1700 of autonomous mapping, as performed by a mobile robot 10, according to an example embodiment. For example, the processing circuitry 70 of the mobile robot 10 is configured to implement the operations comprised in FIG. 17. FIG. 18 illustrates a method 1800, which can be understood as providing example details for the method 1700.

Further methods include, in one embodiment, a method of customizing exploration behavior of a mobile robot that performs mapping using the autonomous mapper described herein. The method includes displaying a user interface corresponding to a physical environment to be mapped by the mobile robot. Here, the mobile robot instantiates an autonomous mapper for exploration of the physical environment, based on selecting frontiers for exploration according to a multi-objective optimization that considers two or more exploration objectives of respective objective types. The method further includes performing any one or more of the following, responsive to receiving corresponding user input via the user interface: limiting search spaces and mapping regions; prioritizing mapping regions; choosing termination criteria and bounding strategies; choosing exploration strategies, constraints, and parameters; choosing static trajectories; customizing relative weights or priorities for multiple exploration objectives; or specifying safety constraints.

A computer-implemented method of providing live feedback and exploration process control of a mobile robot according to one embodiment includes visualizing a map generated by a mobile robot that operates according to the autonomous-mapper details described herein, with the visualization depicting any one or more of obstacles, robot position, planned global and local paths, cost maps and frontiers, frontier priority, blacklisting status. The method further includes providing user input controls for changing frontier priority, blacklisting status, aborting or stopping the exploration process responsive to the robot making an unsafe maneuver, and rolling back a variable number of trajectories responsive to incorrect mapping.

A computer-implemented method of map editing according to one embodiment includes providing a user interface enabling a user to complete or correct a map, as generated by a mobile robot according to the autonomous mapping described herein. The method includes providing options to the user for merging generated maps from multiple exploration runs by the mobile robot.

In at least one embodiment, the autonomous mapper includes a method of computing exploration analytics, comprising one or more of performing evaluation of the previous exploration run, providing output comprising feedback to a user in the form of a recommendation system, and providing output comprising advice for the user for customization and adaptation of future exploration or re-mapping runs.

A computer-implemented user interface method according to one embodiment includes, with respect to exploration by a mobile robot according to the autonomous mapping described herein, performing one or more of: presenting a summary of an exploration run by the mobile robot, presenting exploration analytics and key metrics from the exploration run, and recommending fine-tuning of future exploration runs by the mobile robot.

In at least one embodiment, the autonomous mapper described herein is applied to the use case of automated re-mapping of changed sections in an environment with respect to a prior map of the environment that was obtained manually or using the autonomous mapper. Further, in the same or another embodiment, the autonomous mapper described herein is applied to use case of explorative navigation for discovery of a known target at an unknown location within an environment.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-36. (canceled)

37. A method of autonomous mapping by a mobile robot, the method comprising:
identifying a next frontier for exploration from among two or more candidate frontiers in a map generated by the mobile robot using an online Simultaneous Localization and Mapping (SLAM) algorithm, based on solving a multi-objective optimization that jointly evaluates a set of two or more exploration objectives to determine an attractiveness of each candidate frontier as a next exploration goal, each one of the two or more exploration objectives being a respective type of exploration objective corresponding to a respective exploration behavior;
planning a global path to a global waypoint on the next frontier; and
navigating to the global waypoint according to the global path, subject to collision avoidance and path parameterization determined by local path planning driven by environmental sensors onboard the robot.

38. The method according to claim 37, wherein the set of two or more exploration objectives comprises one or more of mapping speed objectives and at least one of a mapping coverage objective or a mapping consistency objective, the mapping speed objective biasing exploration behavior of the mobile robot towards speed of mapping, the mapping coverage objective biasing exploration behavior of the mobile robot towards completeness of mapping, and the mapping consistency objective biasing exploration behavior of the mobile robot towards correctness and accuracy of mapping.

39. The method according to claim 37, further comprising receiving signaling and adjusting, in response to the received signaling, which two or more exploration objectives from among a defined set of exploration objectives are considered in the multi-objective optimization or determining importance weightings that modify prioritization of individual ones among the two or more exploration objectives considered in the multi-objective optimization.

40. The method according to claim 39, wherein the received signaling is received in conjunction with exchanging signaling with an external computer displaying a user interface for user customization of autonomous mapping behavior by the mobile robot.

41. The method according to claim 37, further comprising applying a user-configured weight to at least one of the two or more exploration objectives, to adjust the multi-objective optimization according to a user preference.

42. The method according to claim 37, wherein the two or more exploration objectives comprise two or more of the following:
a distance-to-goal objective indicating a shortest-path distance from a current location of the mobile robot to the corresponding candidate frontier;
an exploration potential objective indicating an exploration potential associated with the corresponding candidate frontier;
a map coverage objective indicating an extent to which exploration of the corresponding candidate frontier improves coverage by the mobile robot of the physical environment;
a map consistency objective indicating an extent to which exploration of the corresponding candidate frontier exploits previously explored regions of the physical environment; and
a kino-dynamic objective that indicates trajectory smoothness for moving from the current location of the mobile robot to a global waypoint defined on the corresponding candidate frontier.

43. The method according to claim 42, wherein the kino-dynamic objective places lower priorities on paths that are likely to require deviation from a current heading direction of the mobile robot.

44. The method according to claim 37, wherein, solving the multi-objective optimization comprises forming and evaluating a scalarized objective from the two or more objectives, for all candidate frontiers.

45. The method according to claim 37, wherein one of the exploration objectives is a map consistency objective that aims for improving consistency of the online maps generated by the mobile robot, and wherein map consistency is measured using an entropy metric that reflects consistency of the online map over successive time steps of the SLAM algorithm.

46. The method according to claim 45, wherein the map consistency objective is represented by a plurality of sub-objectives including a structure adjacency sub-objective which prefers frontier goals adjacent to visible structure, an exploitation sub-objective which prefers travel by the mobile robot through previously visited or seen areas of the physical environment, and a predictive closure sub-objective that prefers candidate frontiers that are estimated as returning the mobile robot to a seen area that includes a stable landmark.

47. The method according to claim 46, wherein the predictive closure sub-objective predicts and forces the closure of physical loops by the mobile robot through the environment during the exploration process, based on predicting how the physical environment beyond a candidate frontier looks and determining, using a Generative Adversarial Network (GAN) with training and exploration phases of operation, whether a loop closure is possible by navigating through the candidate frontier.

48. The method according to claim 37, further comprising performing a local refinement process, wherein the local refinement process comprises modifying the trajectory to the global waypoint by adding waypoints, enabling the mobile robot to capture local map structures from a variety of viewpoints to improve local map completeness.

49. The method according to claim 37, further comprising using a time-based blacklisting table to deactivate exploration goals that have no viable estimated path from the current position of the mobile robot or for which execution of valid estimated paths results in repeated failures, with the deactivations expiring in a fixed amount of time, after which the exploration goals are reconsidered by the mobile robot for exploration.

50. The method according to claim 37, further comprising applying stopping criteria to exploration by the mobile robot, including one or more of physical bounds, virtual bounds, frontier limits, exploration time, wander distance, threshold limits, or source-to-sink behaviors.

51. The method according to claim 37, further comprising using one or more methods of static trajectory generation comprising any one or more of: use of predefined user-specified landmarks, use of connecting trajectories, use of a wall following behavior, and use of a spinning behavior.

52. The method according to claim 37, wherein planning the global path to the global waypoint on the next frontier imposes multiple constraints on shortest-path computation with respect to the global waypoint, according to a multi-layer cost map.

53. The method according to claim 52, wherein the multi-layer cost map comprises:
a first layer comprising a two-dimensional (2D) static occupancy grid created by the mobile robot performing Simultaneous Localization and Mapping (SLAM) processing, wherein object avoidance is mandatory for obstacles registered in the first layer;
a second layer comprising a dynamic three-dimensional (3D) voxel grid created from point cloud data generated using environmental sensors arranged at different heights onboard the mobile robot, wherein the second layer is periodically refreshed to account for transient obstructions within a working range of the mobile robot;
a third layer comprising a 2D inflation layer that assigns a higher cost for navigation through cells in the first two layers of multi-layer cost map that are closer to obstacles, and lower costs to cells that are farther away; and
a fourth layer comprising a 2D attractor layer that biases the mobile robot to hew alongside walls or other detected structure in the physical environment, when robot localization and map consistency deteriorate.

54. The method according to claim 52, wherein global path plans are further processed by a local planner that performs collision avoidance and generates kino-dynamically feasible paths, while also employing recovery behaviors comprising one or both of cost map alterations and local recovery behaviors including one or more of backtracking, spinning, and U-turning for extrication of the mobile robot from a stuck state.

55. A mobile robot comprising:
a drive system configured to move the mobile robot within a physical environment;
one or more sensors configured to sense obstacles in the physical environment, within corresponding sensing ranges; and
processing circuitry configured to perform the autonomous mapping based on processing sensor data from the one or more sensors and controlling the drive system, wherein the processing circuitry performs the autonomous mapping based on being configured to:
identify a next frontier for exploration from among two or more candidate frontiers in a map generated by the mobile robot using an online Simultaneous Localization and Mapping (SLAM) algorithm, based on solving a multi-objective optimization that jointly evaluates a set of two or more exploration objectives to determine an attractiveness of each candidate frontier as a next exploration goal, each one of the two or more exploration objectives being a respective type of exploration objective corresponding to a respective exploration behavior;
plan a global path to a global waypoint on the next frontier; and
navigate to the global waypoint according to the global path, subject to collision avoidance and path parameterization determined by local path planning driven by the one or more sensors.

56. The mobile robot according to claim 55, wherein the set of two or more exploration objectives comprises one or more mapping speed objectives and at least one of a mapping coverage objective or a mapping consistency objective, the mapping speed objective biasing exploration behavior of the mobile robot towards speed of mapping, the mapping coverage objective biasing exploration behavior of the mobile robot towards completeness of mapping, and the mapping consistency objective biasing exploration behavior of the mobile robot towards correctness and accuracy of mapping.

57. The mobile robot according to claim 55, wherein the processing circuitry is configured to receive signaling and, in response to the received signaling, perform at least one of the following:
select which two or more exploration objectives from among a defined set of exploration objectives are considered in the multi-objective optimization; or
determine importance weightings that modify prioritization of individual ones among the two or more exploration objectives considered in the multi-objective optimization.

58. The mobile robot according to claim 57, wherein the processing circuitry is configured to exchanging signaling with an external computer displaying a user interface for user customization of autonomous mapping behavior by the mobile robot, and wherein the received signaling is received in the exchange.

59. The mobile robot according to claim 55, wherein the processing circuitry is configured to apply a user-configured weight to at least one of the two or more exploration objectives, to adjust the multi-objective optimization according to a user preference.

60. The mobile robot according to claim 55, wherein the two or more exploration objectives comprise two or more of the following:
a distance-to-goal objective indicating a shortest-path distance from a current location of the mobile robot to the corresponding candidate frontier;
an exploration potential objective indicating an exploration potential associated with the corresponding candidate frontier;
a map coverage objective indicating an extent to which exploration of the corresponding candidate frontier improves coverage by the mobile robot of the physical environment;
a map consistency objective indicating an extent to which exploration of the corresponding candidate frontier exploits previously explored regions of the physical environment; and
a kino-dynamic objective that indicates trajectory smoothness for moving from the current location of the mobile robot to a global waypoint defined on the corresponding candidate frontier.

61. The mobile robot according to claim 60, wherein the kino-dynamic objective places lower priorities on paths that are likely to require deviation from a current heading direction of the mobile robot.

62. The mobile robot according to claim 55, wherein, for solving the multi-objective optimization, the processing circuitry is configured to form and evaluate a scalarized objective from the two or more objectives, for all candidate frontiers.

63. The mobile robot according to claim 55, wherein one of the exploration objectives is a map consistency objective that aims for improving consistency of the online maps generated by the mobile robot, and wherein map consistency is measured using an entropy metric that reflects consistency of the online map over successive time steps of the SLAM algorithm.

64. The mobile robot according to claim 63, wherein the map consistency objective is represented by a plurality of sub-objectives including a structure adjacency sub-objective which prefers frontier goals adjacent to visible structure, an exploitation sub-objective which prefers travel by the mobile robot through previously visited or seen areas of the physical environment, and a predictive closure sub-objective that prefers candidate frontiers that are estimated as returning the mobile robot to a seen area that includes a stable landmark.

65. The mobile robot according to claim 64, wherein the predictive closure sub-objective predicts and forces the closure of physical loops by the mobile robot through the environment during the exploration process, based on the processing circuitry being configured to predict how the physical environment beyond a candidate frontier looks and determine, using a Generative Adversarial Network (GAN) with training and exploration phases of operation, whether a loop closure is possible by navigating through the candidate frontier.

66. The mobile robot according to claim 55, wherein the processing circuitry is configured to perform a local refinement process, wherein the local refinement process comprises modifying the trajectory to the global waypoint by adding waypoints, enabling the mobile robot to capture local map structures from a variety of viewpoints to improve local map completeness.

67. The mobile robot according to claim 55, wherein the processing circuitry is configured to use a time-based blacklisting table to deactivate exploration goals that have no viable estimated path from the current position of the mobile robot or for which execution of valid estimated paths results in repeated failures, with the deactivations expiring in a fixed amount of time, after which the exploration goals are reconsidered for exploration.

68. The mobile robot according to claim 55, wherein the processing circuitry is configured to apply stopping criteria to exploration by the mobile robot, including one or more of physical bounds, virtual bounds, frontier limits, exploration time, wander distance, threshold limits, or source-to-sink behaviors.

69. The mobile robot according to claim 55, wherein the processing circuitry is configured to perform static trajectory generation comprising any one or more of: use of predefined user-specified landmarks, use of connecting trajectories, use of a wall following behavior, and use of a spinning behavior.

70. The mobile robot according to claim 55, wherein, with respect to planning the global path to the global waypoint on the next frontier, the processing circuitry is configured to impose multiple constraints on shortest-path computation with respect to the global waypoint, according to a multi-layer cost map.

71. The mobile robot according to claim 70, wherein the multi-layer cost map comprises:
a first layer comprising a two-dimensional (2D) static occupancy grid created by the mobile robot performing Simultaneous Localization and Mapping (SLAM) processing, wherein object avoidance is mandatory for obstacles registered in the first layer;
a second layer comprising a dynamic three-dimensional (3D) voxel grid created from point cloud data generated using environmental sensors arranged at different heights onboard the mobile robot, wherein the second layer is periodically refreshed to account for transient obstructions within a working range of the mobile robot;
a third layer comprising a 2D inflation layer that assigns a higher cost for navigation through cells in the first two layers of multi-layer cost map that are closer to obstacles, and lower costs to cells that are farther away; and
a fourth layer comprising a 2D attractor layer that biases the mobile robot to hew alongside walls or other detected structure in the physical environment, when robot localization and map consistency deteriorate.

72. The mobile robot according to claim 70, wherein global path plans are further processed by a local planner implemented via the processing circuitry that performs collision avoidance and generates kino-dynamically feasible paths, while also employing recovery behaviors comprising one or both of cost map alterations and local recovery behaviors including one or more of backtracking, spinning, and U-turning for extrication of the mobile robot from a stuck state.
